(19) United States
(12) Patent Application Publication
(10) Pub. No.: US 2024/0294062 A1
(43) Pub. Date: Sep. 5, 2024

(54) VEHICLE

(71) Applicant: Polaris Industries Inc., Medina, MN (US)

(72) Inventors: Lalit Malhotra, White Bear Lake, MN (US); Karl L. Hacken, Prescott, WI (US); Andrew C. Hirsch, Corcoran, MN (US); William L. Barbrey, Lino Lakes, MN (US); David J. Hicke, Chisago City, MN (US); Jeffrey J. Schwichtenberg, St. Paul, MN (US); Smeeti Mishra, White Bear Lake, MN (US); Zachary Sundberg, Wyoming, MN (US)

(73) Assignee: Polaris Industries Inc., Medina, MN (US)

(21) Appl. No.: 18/592,643

(22) Filed: Mar. 1, 2024

Related U.S. Application Data
(60) Provisional application No. 63/488,368, filed on Mar. 3, 2023.

(51) Int. Cl. B60K 11/04; B62D 25/08; B62D 25/24; H01Q 1/32

(52) U.S. Cl. CPC B60K 11/04; B62D 25/08; B62D 25/24; H01Q 1/32

(57) ABSTRACT

A vehicle comprises a plurality of ground engaging members and a frame supported by the plurality of ground engaging members and the frame generally comprises a front frame portion. An operator area is supported by the frame and at least one seat is supported by the frame and is positioned within the operator area. A body assembly comprises a plurality of body panels, and the plurality of body panels includes a first body panel supported by the front frame portion and the first body panel comprises an aperture. A second body panel is removably coupled to the frame, and the second body panel is positioned at least partially rearwardly of the first body panel. Further, a passageway is fluidly coupled between the aperture and the operator area, the passageway extends behind the second body panel.

### CROSS-REFERENCE TO RELATED APPLICATIONS

The present disclosure claims priority to U.S. Provisional Application No. 63/488,368, filed Mar. 3, 2023, titled VEHICLE, attorney docket no. PLR-15-30362.01P-US, the complete disclosure of which is expressly incorporated by reference herein.

### FIELD OF THE DISCLOSURE

The present disclosure relates to vehicles, occupant comfort, and components thereof.

### BACKGROUND OF THE DISCLOSURE

Utility and recreational vehicles often have a hard time balancing comfort and performance. The present disclosure relates to occupant comfort, vehicle and technology performance, and related accessories thereof.

### SUMMARY OF THE DISCLOSURE

In embodiments of the present disclosure, a vehicle is provided. A vehicle comprises a plurality of ground engaging members and a frame supported by the plurality of ground engaging members and the frame generally comprises a front frame portion. An operator area is supported by the frame and at least one seat is supported by the frame and is positioned within the operator area. A body assembly comprises a plurality of body panels, and the plurality of body panels includes a first body panel supported by the front frame portion and the first body panel comprises an aperture. A second body panel is removably coupled to the frame, and the second body panel is positioned at least partially rearwardly of the first body panel. Further, a passageway is fluidly coupled between the aperture and the operator area, the passageway extends behind the second body panel.

In another embodiment of the present disclosure, a vehicle is provided. The vehicle comprises a plurality of ground engaging members and a frame supported by the plurality of ground engaging members. An operator area is supported by the frame, and the operator area comprises at least one seat. A powertrain is coupled to at least one of the plurality of ground engaging members and a heat exchanger is supported by the frame, the heat exchanger is positioned forward of the operator area. A panel is positioned longitudinally intermediate the heat exchanger and the operator area, and the panel is configured to divert the air laterally outwardly.

In yet another embodiment of the present disclosure, a vehicle is provided. The vehicle comprises a plurality of ground engaging members and a frame is supported by the plurality of ground engaging members. A steering assembly is coupled to at least one of the plurality of ground engaging members and a camera is positioned adjacent a front of the vehicle. The camera has a viewing angle capable of viewing at least one of the plurality of ground engaging members and a sensor is supported by the frame configured to monitor a vehicle characteristic. A controller is operably coupled to the camera and the sensor and a display is supported by the vehicle. The display is configured to display at least a portion of the viewing angle provided by the camera.

In yet another embodiment of the present disclosure, a vehicle is provided. The vehicle comprises a plurality of ground engaging members and a frame supported by the plurality of ground engaging members. The frame comprises a lower frame portion and an upper frame portion. A first suspension is coupled between the lower frame portion and at least one of the plurality of ground engaging members. An operator area is surrounded by the upper frame portion and at least one seat is positioned within the operator area. A controller is supported by the frame and the controller is operably coupled to a first communication device, a second communication device, and a third communication device. A body assembly comprises a plurality of body panels supported by the frame, the plurality of body panels including a first body panel positioned vertically above a portion of the first suspension, and a panel positioned vertically intermediate the first body panel and the first suspension, the panel configured to receive at least two of the first communication device, and the second communication device and the third communication device.

In yet another embodiment, a vehicle is provided. The vehicle comprises a plurality of ground engaging members and a frame is supported by the plurality of ground engaging members. The frame comprises an upper frame assembly and a lower frame assembly. An open-air operator area is surrounded by the upper frame assembly, and the open-air operator area comprises at least one seat configured to support a passenger. A storage box is accessible to the passenger, and the storage box comprises a storage box frame with an aperture having an aperture perimeter, and a lid is configured to cover the aperture. The storage box further comprises a first lip positioned on the storage box frame. A recess is positioned within the lid, and the recess is configured to receive the first lip. A resilient member is positioned within the recess, and the resilient member is configured to extend between a surface of the recess and the first lip.

### BRIEF DESCRIPTION OF THE DRAWINGS

FIG. 1 is a front left perspective view of a vehicle of the present disclosure;

FIG. 2 is a rear right perspective view of the vehicle of FIG. 1;

FIG. 3A is a left side view of the vehicle of FIG. 1;

FIG. 3B is a left side view of an alternative vehicle of the present disclosure;

FIG. 4 is a top view of the vehicle of FIG. 1;

FIG. 5 is a diagrammatic view of a portion of a powertrain of the present disclosure;

FIG. 6 is a control diagram of a control system of the present disclosure;

FIG. 7A is a top view illustrating a fixed camera and associated viewing angles on a vehicle of the present disclosure;

FIG. 7B is a top view illustrating a movable camera and associated viewing angles on a vehicle of the present disclosure;

FIG. 7C is a left view illustrating at least a portion of the camera angles available to a camera on a vehicle of the present disclosure;

FIG. 8A is a display showing the forward-looking viewing angle of a camera of the present disclosure;

FIG. 8B is a display showing the left-looking viewing angle of a camera of the present disclosure;

FIG. 8C is a display showing the right-looking viewing angle of a camera of the present disclosure;

FIG. 9A is a perspective view of a camera adjacent a grille of a vehicle of the present disclosure;

FIG. 9B is a diagrammatic view of a housing for a side camera of a vehicle of the present disclosure;

FIG. 10 is a perspective view of a hood of a vehicle of the present disclosure;

FIG. 11 is a perspective view of a panel of a vehicle of the present disclosure;

FIG. 12 is an exploded view of the panel of FIG. 11;

FIG. 13 is a side view illustrating a portion of a venting assembly of the present disclosure;

FIG. 14 is a top view illustrating a portion of the venting assembly of FIG. 13;

FIG. 15 is an exploded view illustrating a portion of the venting assembly of FIG. 13 under a fender of a vehicle of the present disclosure;

FIG. 16 is a perspective view of a portion of the venting assembly of FIG. 13 couples to the panel of FIG. 11;

FIG. 17 is an exploded view of the venting assembly of FIG. 13;

FIG. 18 is a perspective view of the hood of FIG. 10 with an air intake panel removed;

FIG. 19 is a perspective view of a wiper fluid bottle of a vehicle of the present disclosure;

FIG. 20A is an exploded view of a wiper fluid bottle and deflector shield of the present disclosure;

FIG. 20B is an exploded view of the wiper fluid bottle of FIG. 20A;

FIG. 21 is a perspective view of a wiper assembly and a windshield of a vehicle of the present disclosure;

FIG. 22 is a perspective view of the deflector shield of FIG. 20 of a vehicle of the present disclosure;

FIG. 23 is a front perspective view of the deflector shield of FIG. 22;

FIG. 24 is a side view of the deflector shield of FIG. 22;

FIG. 25 is a perspective view of an alternate deflector shield of a vehicle of the present disclosure;

FIG. 26 is a front perspective view of the deflector shield of FIG. 25;

FIG. 27 is a rear perspective view of the deflector shield of FIG. 25;

FIG. 28 is a side view of the deflector shield of FIG. 25;

FIG. 29 is a perspective view of a storage box assembly of a vehicle of the present disclosure;

FIG. 30 is an exploded view of a lid of the storage box assembly of FIG. 29;

FIG. 31 is a cross-section view of the storage box assembly of FIG. 29;

FIG. 32 is a close up of a sealing structure of the storage box assembly of FIG. 29 taken at section 32 of FIG. 31;

FIG. 33 is a front perspective view of a speaker and windshield of a vehicle of the present disclosure;

FIG. 34 is a rear perspective view of the speaker and windshield of FIG. 33;

FIG. 35 is an exploded view of the speaker and windshield of FIG. 33;

FIG. 36A is a rear left perspective view of a speaker of the present disclosure;

FIG. 36B is an exploded view of the speaker of FIG. 36A;

FIG. 37 is an exploded view of the speaker of FIG. 36A installed on a vehicle of the present disclosure;

FIG. 38 is a rear perspective view of a front frame assembly of a vehicle of the present disclosure with a bumper;

FIG. 39 is an exploded view of the front frame assembly and bumper of FIG. 38;

FIG. 40 is an exploded view of a coupling assembly of the front frame assembly and bumper of FIG. 38;

FIG. 41 is a partially exploded view of the coupling assembly of FIG. 40;

FIG. 42 is a cross-section view of the coupling assembly of FIG. 40, taken along line 42-42 of FIG. 41;

FIG. 43 is a control diagram for controlling lights or other accessories;

FIG. 44A is an alternative control diagram for controlling lights or other accessories;

FIG. 44B is a portion of the alternative control diagram of FIG. 44A;

FIG. 44C is a portion of the alternative control diagram of FIG. 44A;

FIG. 45 is a perspective view of a speaker of the present disclosure;

FIG. 46 is an exploded view of the speaker of FIG. 45;

FIG. 47 is a rear exploded view of the speaker of FIG. 45; and

FIG. 48 is a side view of the mounting arrangement of the speaker of FIG. 45.

### DETAILED DESCRIPTION OF THE DRAWINGS

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

In some instances throughout this disclosure and in the claims, numeric terminology, such as first, second, third, and fourth, is used in reference to various operative transmission components and other components and features. Such use is not intended to denote an ordering of the components. Rather, numeric terminology is used to assist the reader in identifying the component being referenced and should not be narrowly interpreted as providing a specific order of components.

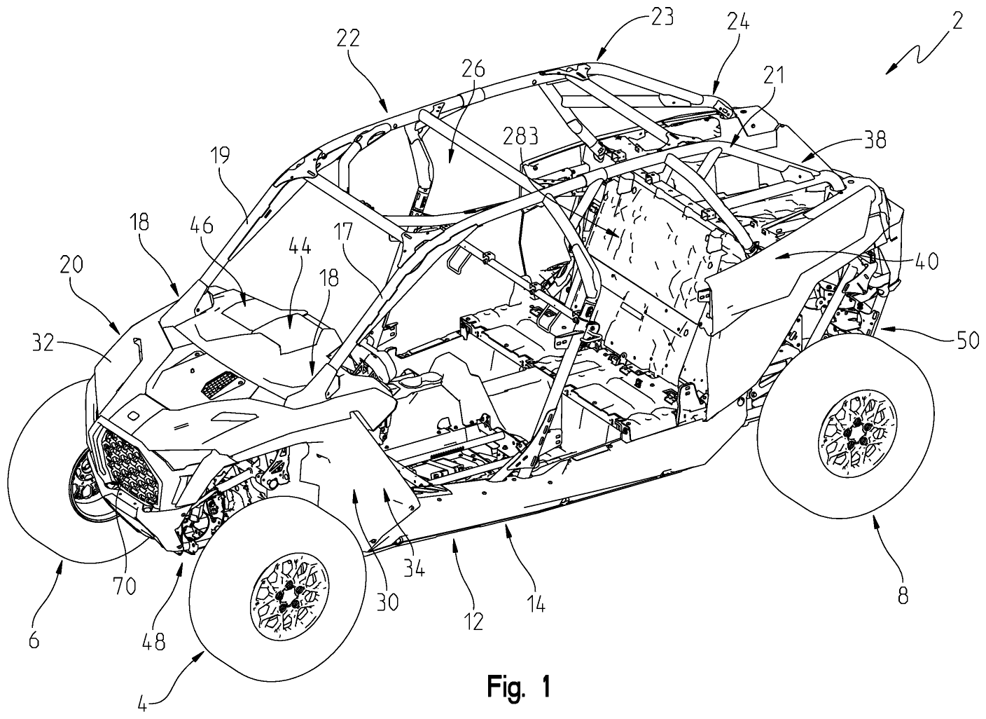

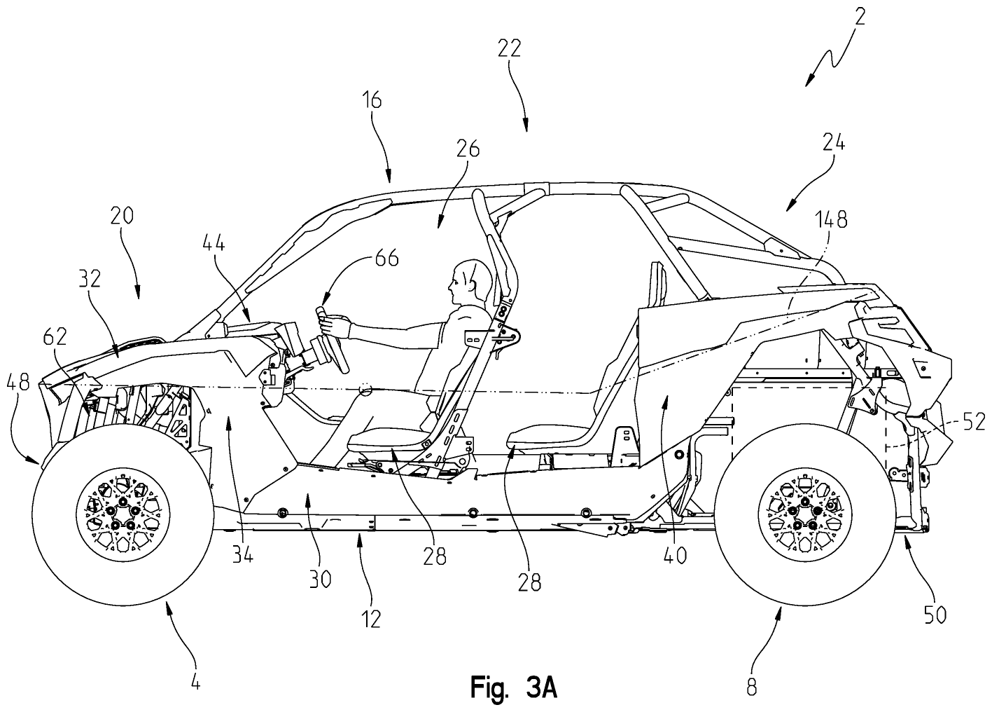

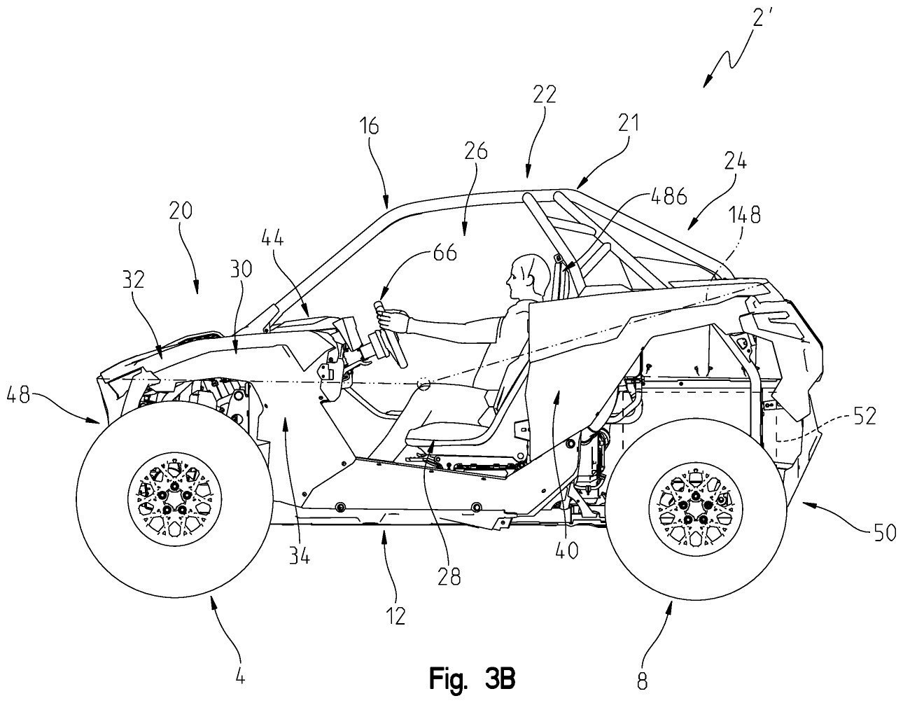

In some instances throughout this disclosure, various components may be described in reference to either a vehicle 2 (FIG. 1) or a vehicle 2′ (FIG. 3B). Vehicle 2 and vehicle 2′ are separate vehicles, distinct primarily in the number of occupants they are able to hold, however it should be appreciated that any or all components and methods of use of the disclosure described herein may be applied to either of vehicle 2 or vehicle 2′.

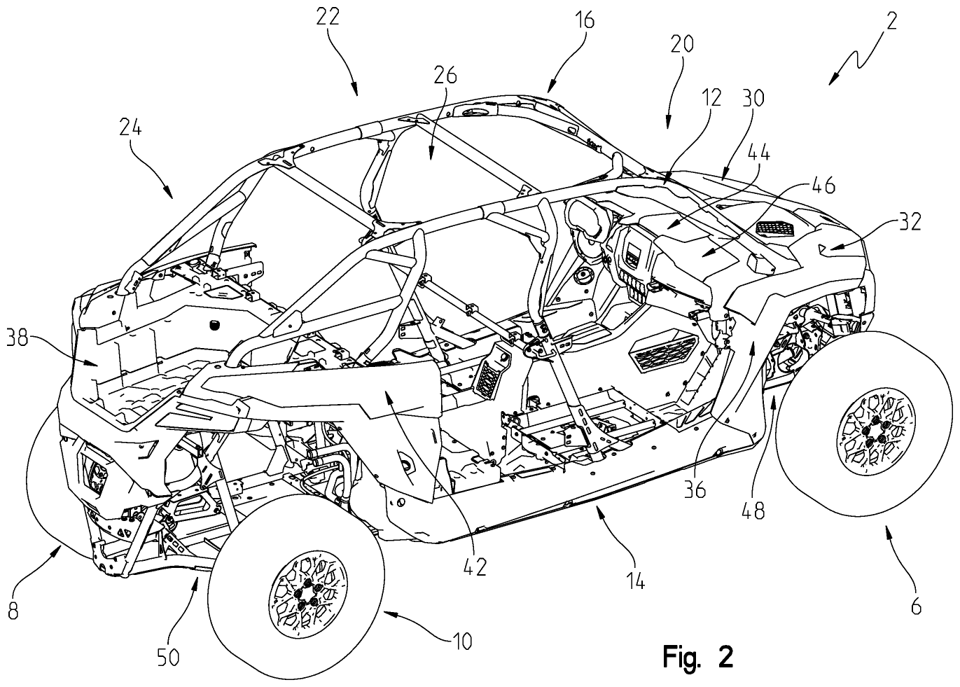

Now referring to FIGS. 1-4B, a vehicle 2 is provided comprising a plurality of ground engaging members including a front left ground engaging member 4, a front right ground engaging member 6, a rear left ground engaging member 8, and a rear right ground engaging member 10. In embodiments, ground engaging members 4, 6, 8, 10 are wheels. In various embodiments, ground engaging members may comprise skis, tracks, or other types of ground engaging members. In embodiments, vehicle 2 comprises four ground engaging members, however, vehicle 2 may comprise any number of ground engaging members including two ground engaging members, three ground engaging members, five ground engaging members, six ground engaging members, or more ground engaging members.

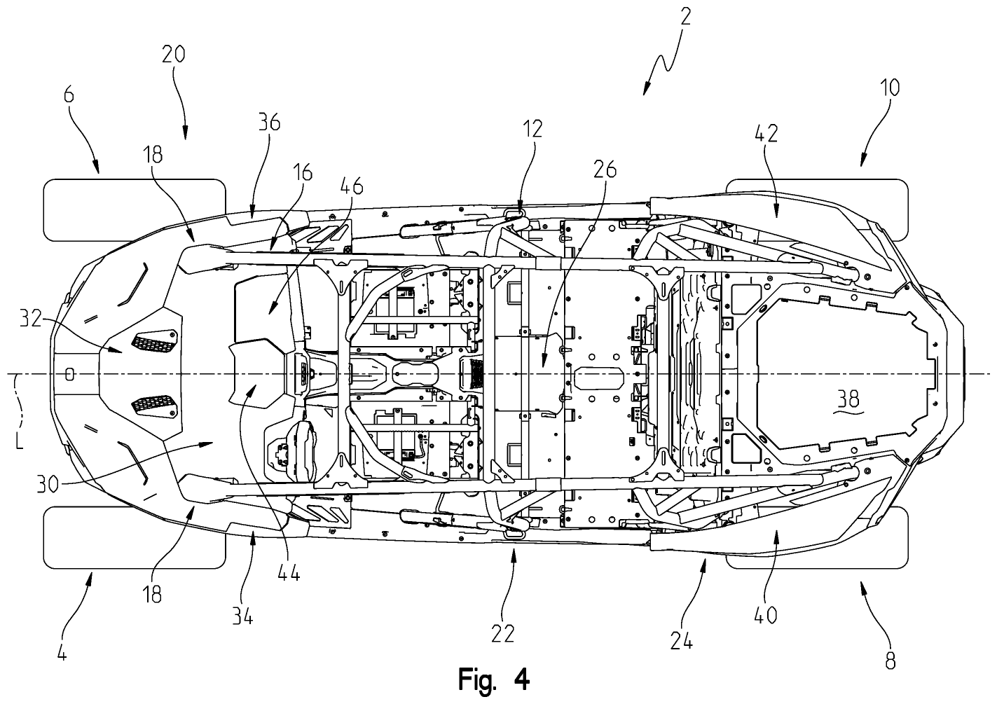

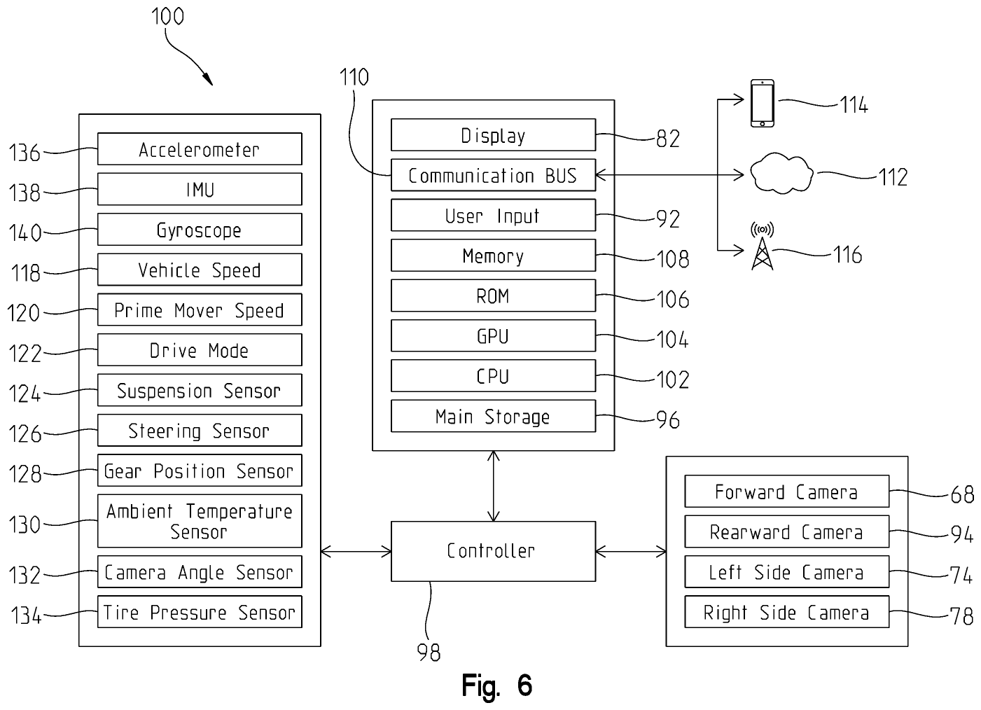

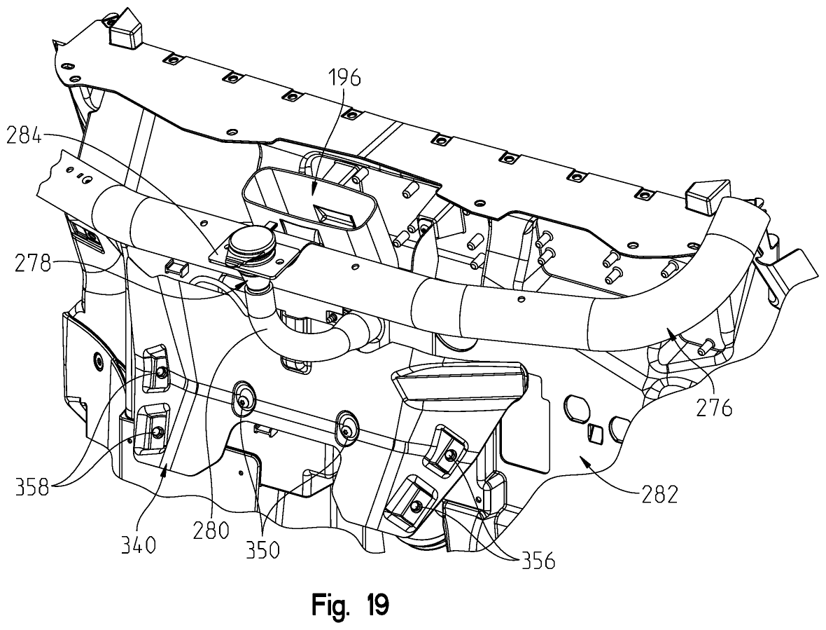

Vehicle 2 comprises a frame 12 supported by the plurality of ground engaging members 4, 6, 8, 10 extending along a vehicle longitudinal centerline L (FIG. 4). Frame 12 generally comprises a lower frame portion 14 and an upper frame portion 16. Illustratively, lower frame portion 14 is coupled to upper frame portion 16 at a plurality of coupling locations including front coupling locations 18. Upper frame portion 16 comprises a first generally upstanding frame member 17 and a second generally upstanding frame member 19 extending upwardly from each coupling location 18. Frame 12 generally comprises a front frame portion 20, a middle frame portion 22, and a rear frame portion 24. In embodiments, a third generally upstanding frame member 21 is positioned within rear frame portion 24 and a fourth generally upstanding frame member 23 is positioned within rear frame portion 24, and third generally upstanding frame member 21 and fourth generally upstanding member 23 are laterally aligned. Upper frame portion 16 generally surrounds an operator area 26 configured to support at least one seat 28 (FIG. 3A) to hold a passenger. In various embodiments, vehicle 2 comprises a single seat, a pair of seats, three seats, four seats, or more seats. Operator area 26 also comprises a dashboard 44 which may comprise a display 82 (FIG. 6) and a storage box assembly 46. In embodiments, a front panel 282 (FIG. 19) is positioned forward of operator area 26 and a rear panel 283 is positioned rearward of operator area 26.

Still referring to FIGS. 1-4B, vehicle 2 comprises a body assembly 30 supported by frame 12. Body assembly 30 generally comprises a plurality of body panels, including a hood 32 positioned generally forwardly of upper frame portion 16 and operator area 26, a front left fender 34 positioned above front left ground engaging member 4, a front right fender 36 positioned above front right ground engaging member 6, a rear left fender 40 positioned above rear left ground engaging member 8, and a rear right finder 42 positioned above rear right ground engaging member 10. Body assembly 30 also comprises a utility bed 38 positioned rearward of operator area 26.

Vehicle 2 also comprises a front suspension 48 coupled between frame 12 and a pair of the plurality of ground engaging members and a rear suspension 50 coupled between frame 12 and a pair of the plurality of ground engaging members. In embodiments, front suspension 48 may be a dual A-arm suspension, a strut suspension, or another type of suspension, and rear suspension 50 may be a dual A-arm suspension, a trailing arm suspension, a strut suspension, or another type of suspension. A first linear force element (not shown) is positioned generally intermediate frame 12 and the front suspension adjacent front left ground engaging member 4, a second linear force element (not shown) is positioned generally intermediate frame 12 and the front suspension adjacent front right ground engaging member 6, a third linear force element (not shown) is positioned generally intermediate frame 12 and the rear suspension adjacent rear left ground engaging member 8, and a fourth linear force element (not shown) is positioned generally intermediate frame 12 and the rear suspension adjacent rear right ground engaging member 10. In various embodiments, each linear force element is a shock absorber. A steering assembly (not shown) is coupled to at least one of the plurality of ground engaging members. Illustratively, steering assembly comprises a steering input 66 configured to provide a steering input to front left ground engaging member 4 and front right ground engaging member 6.

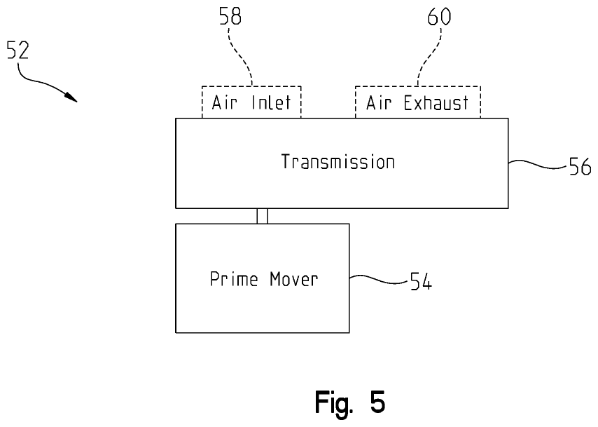

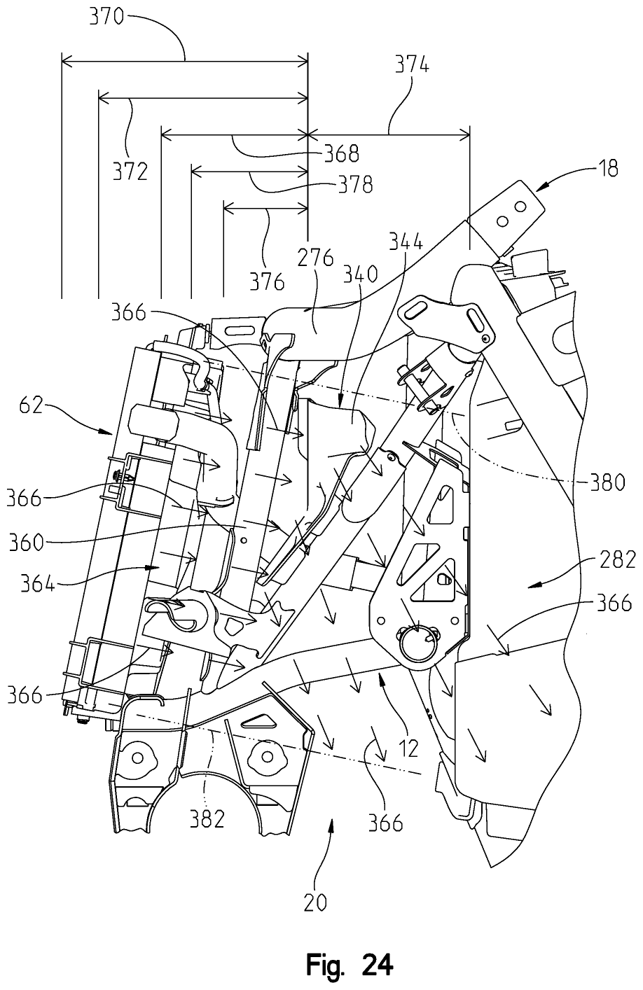

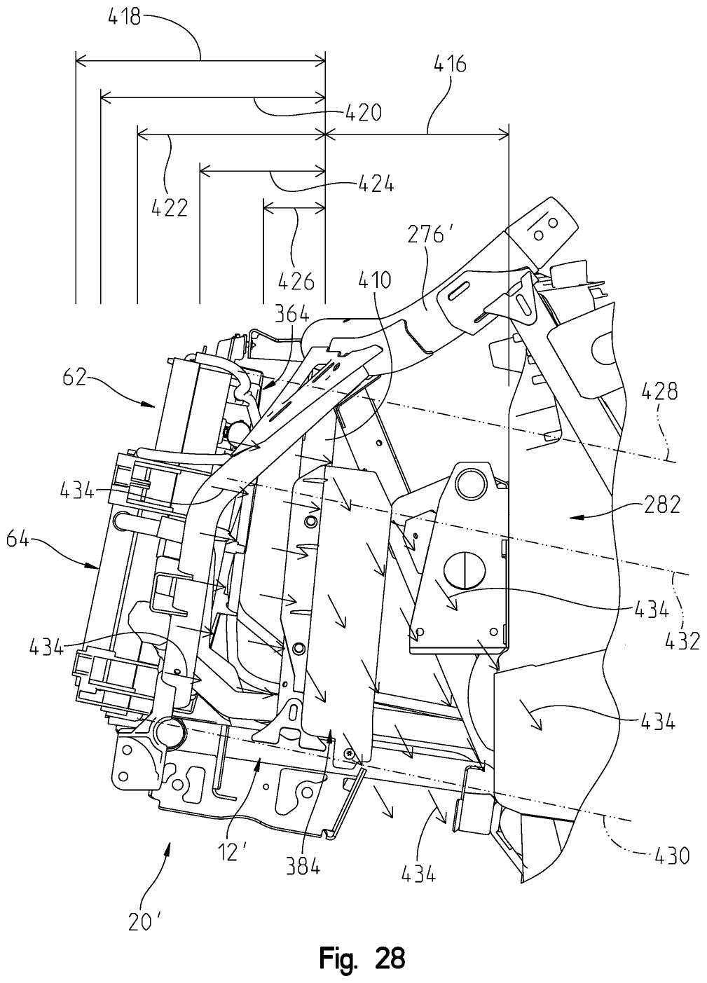

Vehicle 2 also comprises a powertrain 52 (FIG. 5) comprising a prime mover 54, and a transmission 56 coupled to the prime mover 54. Transmission 56 may be comprised of one or more of a continuously variable transmission (CVT) and a shiftable transmission. An air inlet 58 is fluidly coupled to transmission 56 and an air outlet 60 is fluidly coupled to transmission 56. In embodiments, air inlet 58 is configured to provide fresh air to transmission 56 (e.g., CVT) to keep a belt (not shown) and a plurality of sheaves (not shown) cooled. Air outlet 60 is configured to expel, or exhaust, air within CVT 56. In embodiments, prime mover 54 may be an internal combustion engine with an air intake assembly (not shown), an exhaust assembly (not shown), and a cooling assembly including a first heat exchanger 62 (e.g., radiator, FIG. 24) and a second heat exchanger 64 (e.g., radiator, FIG. 28).

Referring now to FIG. 6, vehicle 2 includes an exemplary processing system 100. Processing system 100 includes a controller 98 communicably coupled to a user input 92, a display 82, a main storage 96, a central processing unit (CPU) 102, a graphics processing unit (GPU) 104, a read-only memory (ROM) 106, a main memory 108, and a communication BUS 110.

In some examples, CPU 102 and/or GPU 104 includes one or more general purpose microprocessors. In some examples, the main memory 108 (e.g., random access memory (RAM), cache and/or other dynamic storage devices) is configured to store information and instructions to be executed by the CPU 102 and/or GPU 104. In certain examples, the main memory 108 is configured to store temporary variables or other intermediate information during execution of instructions to be executed by CPU 102 and/or GPU 104. For example, the instructions, when stored in the main storage 96 accessible to CPU 102 and/or GPU 104, render the computing system 100 into a special-purpose machine that is customized to perform the operations specified in the instructions, described herein. In some examples, the ROM 106 is configured to store static information and instructions for the CPU 102 and/or GPU 104. In certain examples, the main storage 96 (e.g., a magnetic disk, optical disk, or flash drive) is configured to store information and instructions.

Thus, computing system 100 may include at least some form of computer readable media. The computer readable media may be any available media that can be accessed by CPU 102 and/or GPU 104 or other devices. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may not include communication media.

In some embodiments, the display 82 (e.g., a cathode ray tube (CRT), an LCD display, or a touch screen) is configured to display information to a user of the computing system 100. In some examples, the input device 92 (e.g., alphanumeric and other keys) is configured to communicate information and commands to the CPU 102 and/or GPU 104.

Computing system 100 may also configured to communicate with one or more networks through communication BUS 110. That is, communication BUS may be communicably coupled to a mobile device 114, a network 112 (e.g., cellular network), a radio network 116, or another communication network. Additional details regarding communication networks and methods of use thereof can be found in U.S. Pat. No. 9,324,195, issued Apr. 26, 2016, titled RECREATIONAL VEHICLE INTERACTIVE, TELEMETRY, MAPPING, AND TRIP PLANNING SYSTEM; U.S. Pat. No. 10,038,977, issued Jul. 31, 2018, titled RECREATIONAL VEHICLE GROUP MANAGEMENT SYSTEM; U.S. Pat. No. 11,531,333, issued Dec. 20, 2022, titled COMMUNICATION AND RELAY SYSTEMS FOR VEHICLES; U.S. patent application Ser. No. 17/506,249, filed Apr. 21, 2022, titled VEHICLE COMMUNICATION AND MONITORING, attorney docket no. PLR-886-29463.03P-US, the entire disclosures of which are expressly incorporated herein by reference.

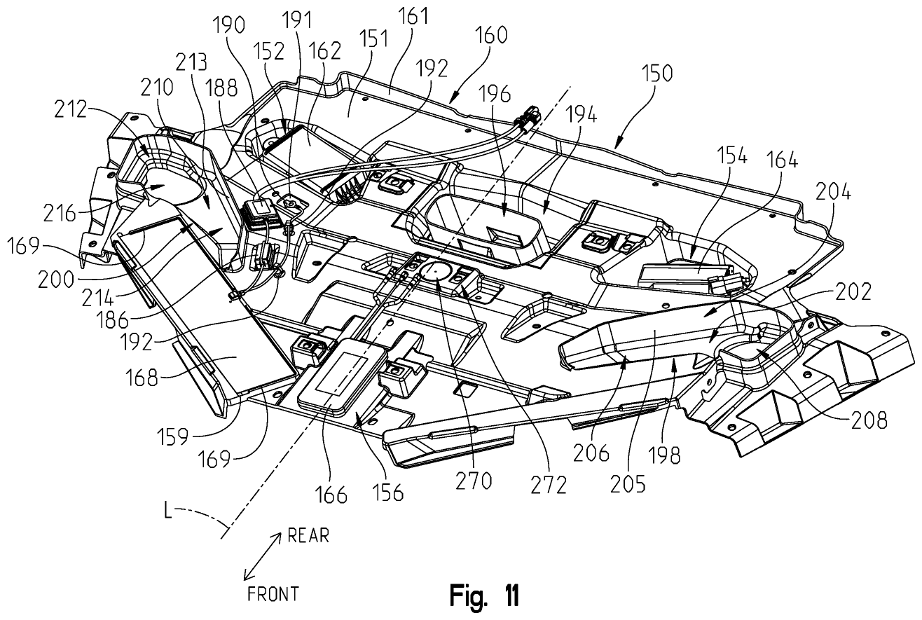

Still referring to FIG. 6, controller 98 is communicably coupled to one or more sensors configured to monitor one or more vehicle characteristics such as a vehicle speed 118, a prime mover speed 120, a drive mode 122, a suspension sensor 124, a steering sensor 126, a gear position sensor 128, an ambient temperature sensor 130, a camera angle sensor 132, and a tire pressure sensor 134. Vehicle speed 118 may be determined by a wheel speed sensor, a GPS 166 (FIG. 11), or another sensor. Prime mover speed 120 may be determined by a rotational sensor on a crankshaft of an internal combustion engine or a rotational sensor on an electric motor. Prime mover speed 120 may also be determined by another type of sensor. Drive mode 122 may be selected by a user through user input 92, through display 82, or by another type of input; exemplary drive modes include a Comfort Mode, a Race Mode, a Track Mode, and a Rock Mode. Suspension sensor 124 may be a shock position sensor configured to determine a shock length, a suspension position, a suspensions stiffness, or another suspension characteristic. In various embodiments, a shock position sensor is positioned at a shock corresponding to each of ground engaging members 4, 6, 8, 10. Steering sensor 126 may be a steering angle sensor, a power steering sensor, a steering position sensor or another type of steering sensor. Gear position sensor 128 is configured to detect a position of transmission 56 (e.g., shiftable transmission). Ambient temperature sensor 130 may be a thermocouple, a thermometer, or another type of temperature sensor configured to determine an outside temperature. Camera angle sensor 132 may be a sensor configured to determine a rotational/translational position of a camera 68, described herein. Tire pressure sensor 134 may be a Bluetooth sensor communicably coupled to exemplary processing system 100 configured to determine a pressure within any or all of wheels 4, 6, 8, 10.

In various embodiments, controller 98 is also coupled to an accelerometer 136, an Inertial Measurement Unit (IMU) 138, and a Gyroscope 140. Accelerometer 136 may be used to determine linear accelerations experienced by vehicle 2, such as a lateral acceleration, a longitudinal acceleration, and a vertical acceleration. IMU 138 may be used to determine linear accelerations, angular accelerations, an orientation of vehicle 2, and forces experienced by vehicle 2. Gyroscope 140 may be used to measure angular velocity and determine an orientation of vehicle 2. Additional details about how accelerometer 136, IMU 138, gyroscope 140, and various shock positions sensors can be found in U.S. patent application Ser. No. 17/235,322, filed Oct. 21, 2021, titled SYSTEMS AND METHODS FOR OPERATING AN ALL-TERRAIN VEHICLE, attorney docket no. PLR-15-29107.02P-US; U.S. Pat. No. 11,110,913, issued Sep. 7, 2021, titled VEHICLE HAVING ADJUSTABLE SUSPENSION, attorney docket no. PLR-15-25091.08P-US; U.S. patent application Ser. No. 17/379,675, filed Jan. 20, 2022, titled ADJUSTABLE SUSPENSIONS AND VEHICLE OPERATION FOR OFF-ROAD RECREATIONAL VEHICLES, attorney docket no. PLR-15-29249.04P-US, the entire disclosures of which are expressly incorporated herein by reference.

### Cameras and Methods of Display

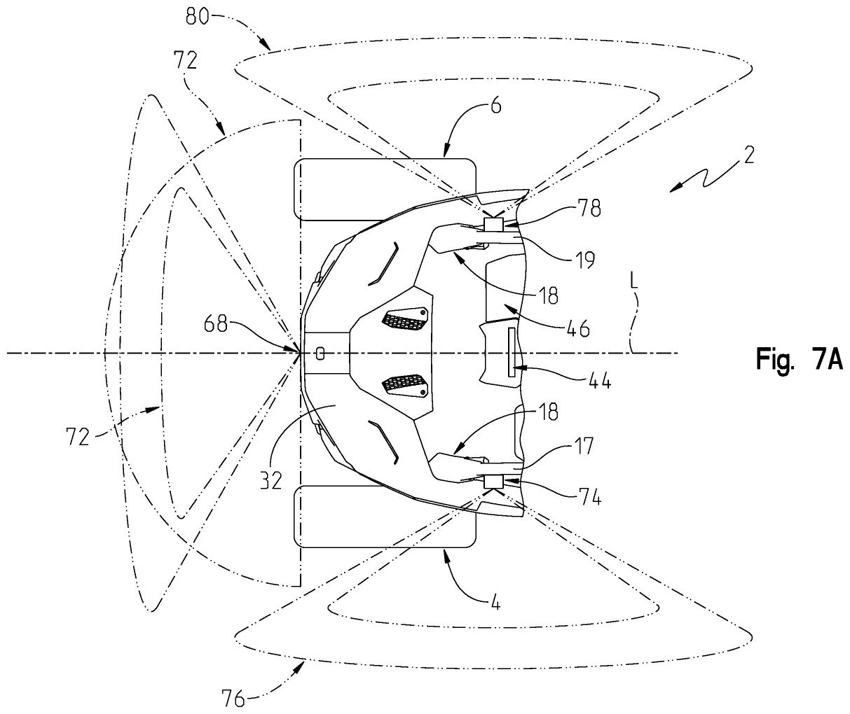

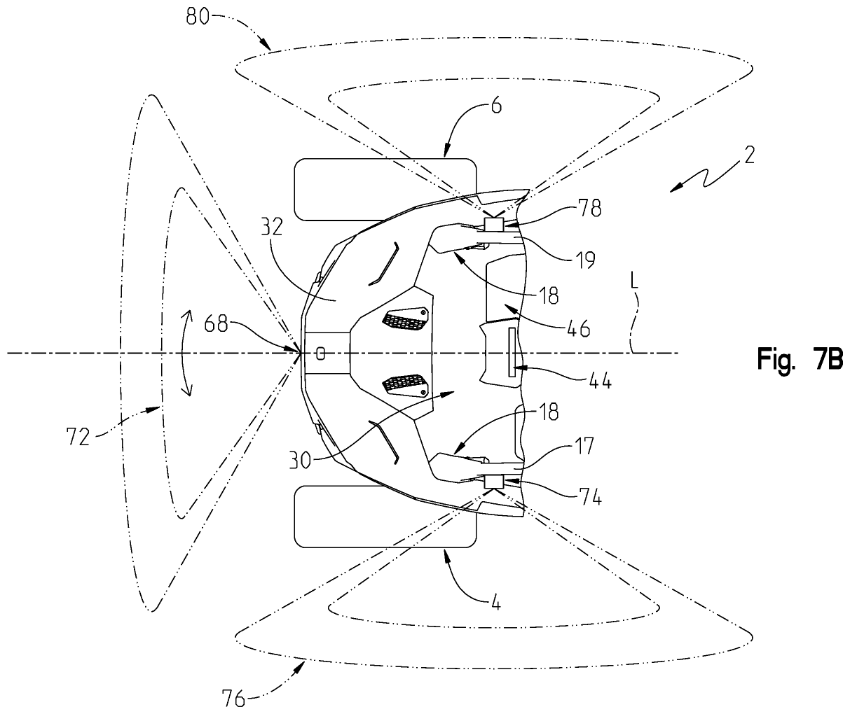

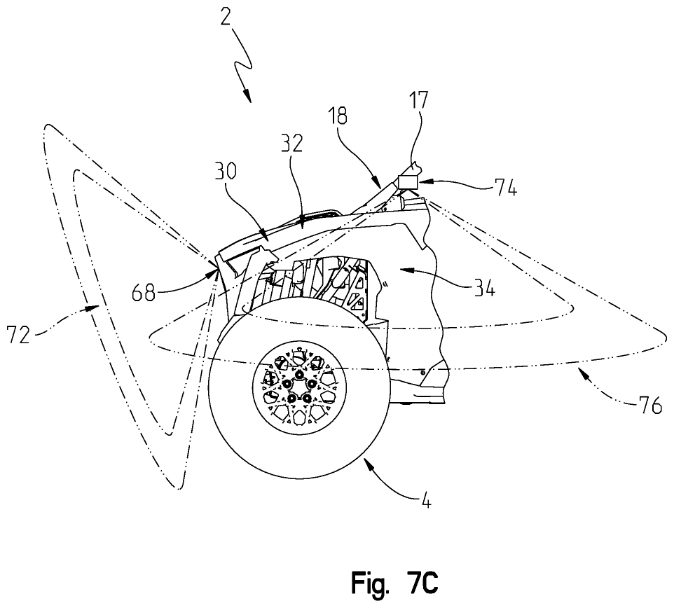

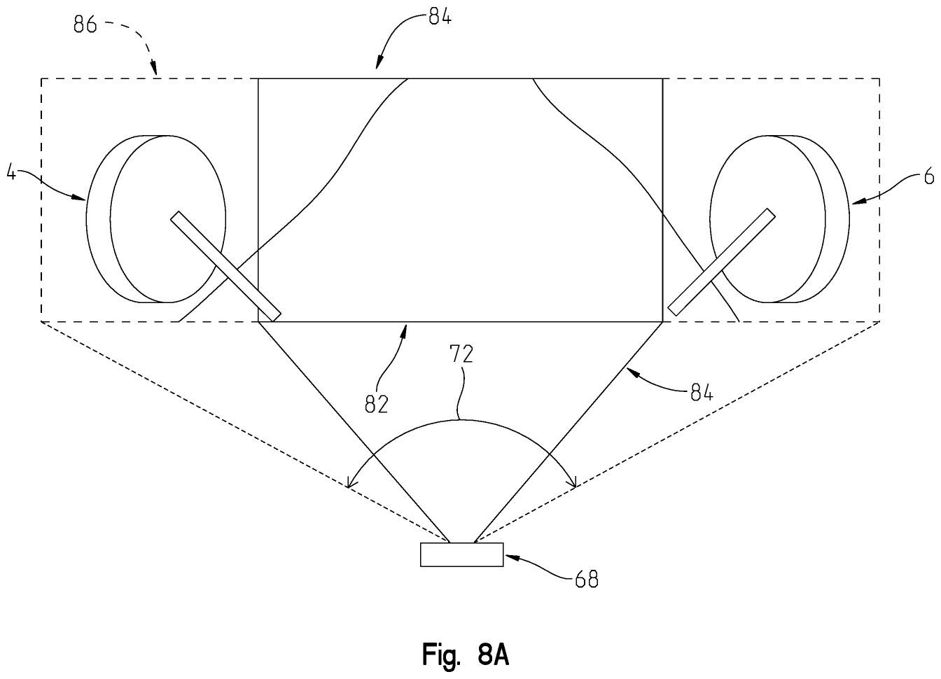

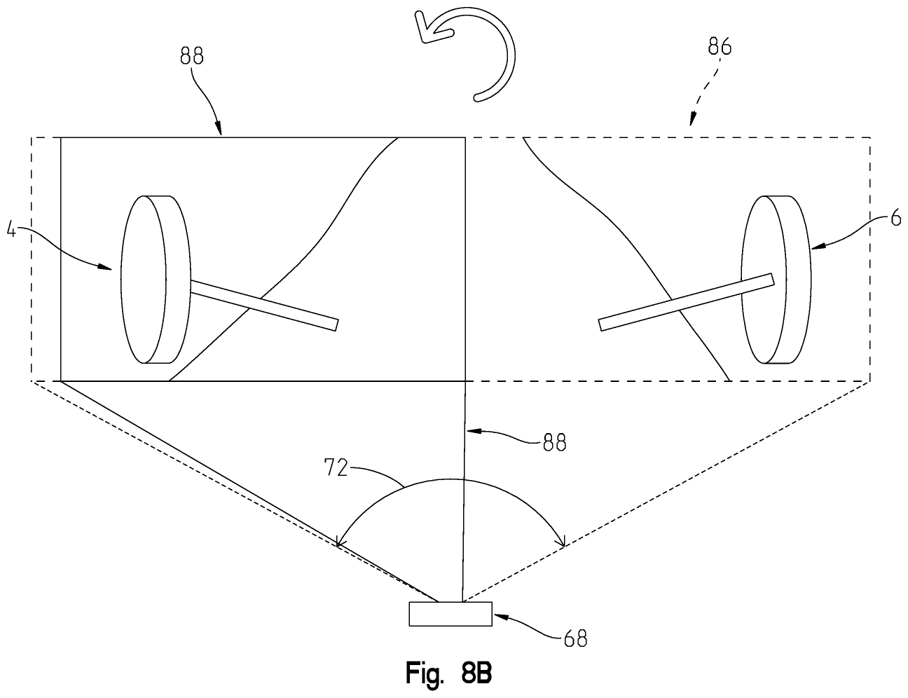

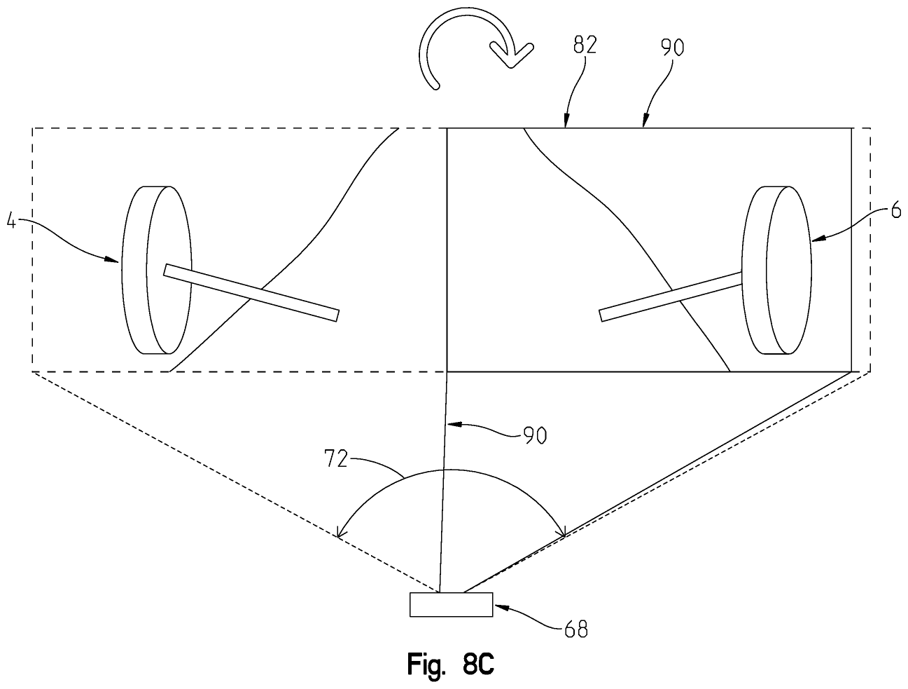

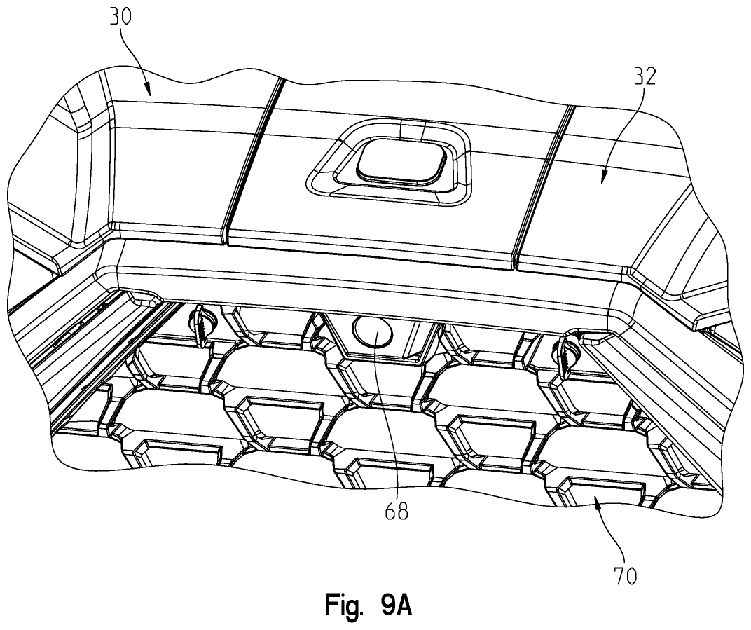

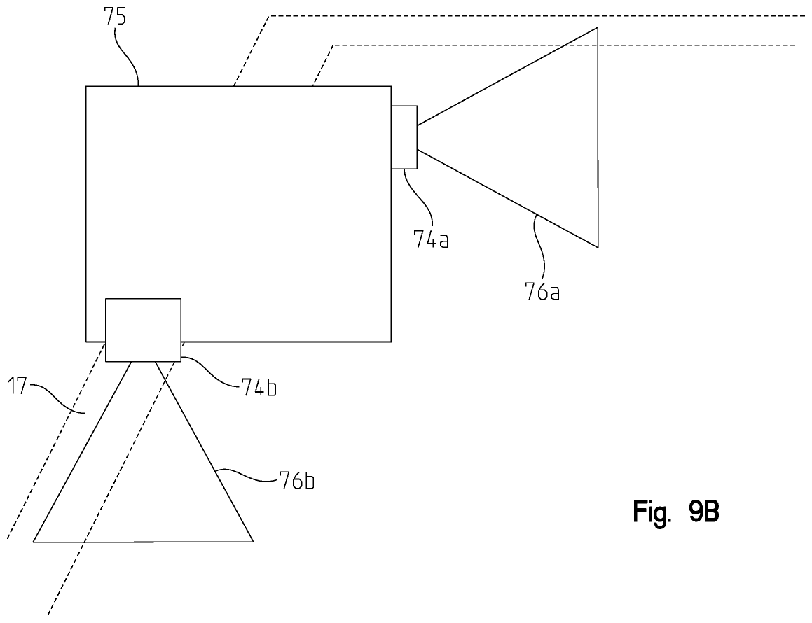

Now referring to FIGS. 6-8C, vehicle 2 comprises a forward camera 68 positioned adjacent a front of vehicle 2. Forward camera 68 is positioned along longitudinal centerline L and positioned within a grille 70 of vehicle 2. As shown in FIG. 9A, forward camera 68 is positioned an upper extent of grille 70. In embodiments, grille 70 has a honeycomb pattern, and camera 68 is positioned within an aperture of the honeycomb pattern to blend in with the pattern. Referring to FIG. 7A, in various embodiments, forward camera 68 is a stationary wide-angle lens and has a viewing angle 72 approximately equal to 180 degrees providing a viewing area 86 (FIG. 8A). In various embodiments, viewing angle 72 is between 150 degrees and 210 degrees. In various embodiments, viewing angle 72 is 90 degrees or more. Referring to FIG. 7B, in various embodiments, forward camera 68 is a movable camera, or a movable lens, and has a viewing angle 72 of approximately 30 degrees to 120 degrees. In various embodiments, forward camera 68 is a movable camera or lens and has a viewing angle 72 of approximately 40 degrees. In various embodiments, the movable camera may be rotated and/or translated left-to-right and may further be rotated and/or translated up-and-down to increase the total area camera 68 may view. In the case of a movable camera, the viewing angle is consistent, however, the viewing area 86 is as large as the movable camera is able to move to view.

Vehicle 2 may also comprise a left side camera 74 with a viewing angle 76 and a right side camera 78 with a viewing angle 80. In embodiments, left side camera 74 is positioned on upstanding frame member 17 and right side camera 78 is positioned on upstanding frame member 19. In various embodiments, each camera 74, 78 is positioned adjacent coupling points 18. In various embodiments, each camera 74, 78 is positioned adjacent a top of upstanding frame member 17 and upstanding frame member 19, respectively. In various embodiments, left side camera 74 and right side camera 78 are aimed downwardly to provide a viewing area of the ground near front left ground engaging member 4 and front right ground engaging member 6, respectively. In various embodiments, each of left side camera 74 and right side camera 78 are aimed rearwardly to provide a rear-view perspective of either side of vehicle 2. Left side camera 74 and right side camera 78 may each be stationary providing a single viewing angle. In various embodiments, left side camera 74 and right side camera 78 may be rotatable and/or translatable to increase the amount of area viewable by cameras 74 and 78.

Referring now to FIG. 9B, in embodiments, left side camera 74 and right side camera 78 are coupled to a side mirror, or a housing 75. Housing 75 may be placed on one of upstanding frame member 17 or upstanding frame member 19. In embodiments, left side camera 74 in a first housing 75 is coupled to upstanding frame member 17 and right side camera 78 in a second housing 75 is coupled to upstanding frame member 19. In embodiments, each of left side camera 74 and right side camera 78 is comprised of one or more cameras. As shown in FIG. 9B, a first camera 74a may be facing forwardly while a second camera 74b may be facing downwardly. In embodiments, first camera 74a has a first viewing angle 76a and second camera 74b has a second viewing angle 76b. In embodiments, either of first viewing angle 76a or second viewing angle 76b may be displayed on display 82.

Vehicle 2 may also include a rear camera 94 (FIG. 6) configured to provide a viewing angle of the rear of vehicle 2. Rear camera 94 may be configured to provide a viewing angle of one or more of rear left ground engaging member 8 and rear right ground engaging member 10.

Referring now to FIGS. 8A-8C, a display 82 is configured to display an output of one or more of cameras 68, 74, 78, 94. Illustratively, a first portion 84 of viewing area 86 is displayed on display 82, and the first portion 84 is representative of the visible area within viewing angle 72 of camera 68. In embodiments, display 82 is positioned within operator area 26. Display 82 may be positioned on dashboard 44 and in reach and/or view of an operator and/or passenger of vehicle 2. In embodiments, display 82 is positioned adjacent storage box assembly 46.

As shown in FIG. 8A, viewing area 86 is representative of the 180-degree range provided by camera 68 with viewing angle 72. That is, because camera 68 is positioned adjacent a front of vehicle 2 and viewing angle 72 is 180 degrees, viewing area 86 includes both front left ground engaging member 4 and front right ground engaging member 6. In embodiments, display 82 is configured to display only first portion 84 of viewing area 86. Camera 68 is a wide-angle lens, and to fit an image with an appropriate screen resolution on display 82, a smaller portion (e.g., first portion 84) of the entire viewing area 86 is displayed on display 82.

In various embodiments, the portion (e.g., first portion 84) of viewing area 86 displayed on display 82 is changeable and/or selectable. Shown in FIG. 8B, viewing area 86 remains unchanged, and display 82 is configured to show a second portion 88 of viewing area 86. In various embodiments, display 82 changes from displaying first portion 84 to second portion 88 via a user input 92 (FIG. 8). In embodiments, user input 92 may be a touch screen button on display 82, a tactile button, a slider, a knob, or another type of user input. Illustratively, second portion 88 is configured to show front left ground engaging member 4 so that an operator of vehicle 2 may more easily steer (i.e., place) front left ground engaging member 4 when operating vehicle 2. Referring now to FIG. 8C, viewing area 86 remains unchanged, and display 82 is configured to show a third portion 90 of viewing area 86. In various embodiments, display 82 changes from display first portion 84 or second portion 88 to third portion 90 via user input 92.

In various embodiments, the portion (e.g., first portion 84, second portion 88, third portion 90) of viewing area 86 displayed on display 82 is automatically changed based upon a detected sensor value (e.g., from any one of the plurality of sensors previously described). In various embodiments, display 82 is configured to display a default screen configuration which may include variables such as vehicle speed, drive mode, prime mover speed, etc. In various embodiments, when a user selects the Rock Mode from among the list of possible Drive Modes, display 82 is automatically configured to display any of first portion 84, second portion 88, or third portion 90. In various embodiments, Rock Mode may be labeled in a variety of ways. In embodiments, Rock Mode is indicative of a Drive Mode that may be configured for slower vehicle speed, slower turning rates, a lower torque, or other vehicle characteristics. In various embodiments, display 82 is configured to display any of first portion 84, second portion 88, or third portion 90 based upon a detected steering angle. Referring to FIG. 8A, if controller 98 determines that a steering angle is approximately zero, or neutral (i.e., wheels pointed straight), display 82 is configured to display first portion 84 so that the operator of vehicle 2 can see directly ahead, where vehicle 2 is directed. Referring to FIG. 8B, if controller 98 determines that a steering angle is a left turning value (i.e., wheels pointed left), display 82 is configured to display second portion 88 so that the operator of vehicle 2 can see front left ground engaging member 4, and may be better equipped to steer, or place front left ground engaging member 4 amongst rocks, obstacles, or other terrain. Referring to FIG. 8C, if controller 98 determines that a steering angle is a right turning value (i.e., wheels pointed right), display 82 is configured to display third portion 90 so that the operator of vehicle 2 can see front right ground engaging member 6, and may be better equipped to steer, or place front right ground engaging member 6 amongst rocks, obstacles or other terrain.

In various embodiments, controller 98 is configured detect, by gear position sensor 128, that transmission 56 is in a reverse gear, and in response to the reverse gear, display a viewing area from rear camera 94. That is, display 82 automatically displays the view of the rear camera 94 when the vehicle is likely going to be going in the reverse direction.

In various embodiments, controller 98 is configured to detect and determine a shock position based upon a detected value from one or more suspension sensors 124. In various embodiments, display 82 is configured to display one of first portion 84, second portion 88, and third portion 90 in response to the detected value from the one or more suspension sensors 124. In various embodiments, one of the suspension sensors 124 adjacent front left ground engaging member 4 may detect that the shock is in a compressed state, indicating that the front-left of vehicle is experiencing an event such as a vehicle landing, a rock crawling event, or a vehicle turn.

In various embodiments, controller 98 may detect that vehicle 2 is in a turning event. In various embodiments, controller 98 detects that vehicle 2 is in a turning event based upon a steering angle (i.e., steering angle value is greater than a threshold value). In various embodiments, controller 98 detects that vehicle 2 is in a turning event based upon detecting, by at least one of the one or more suspension sensors 124, that one of the shock absorbers between frame 12 and the front suspension 48 is compressed and also determining that the vehicle speed 118 is above a threshold value (e.g., 10 mph). In various embodiments, controller 98 detects that vehicle 2 is in a turning event based upon a detected acceleration value from any of accelerometer 136, IMU 138, or gyroscope 140. That is, if the detected acceleration value from any of accelerometer 136, IMU 138, or gyroscope 140 is greater than a threshold value, controller 98 determines vehicle 2 is in a turning event. In embodiments, when controller 98 detects that vehicle 2 is in a turning event, display 82 is configured to display either of the second portion 88 or the third portion 90 in order to display the inside wheel during the turning event. In various embodiments, during a turning event, display 82 is configured to display either of the second portion 88 or the third portion 90 in order to display the outside wheel during the turning event. That is, in one embodiment, controller 98 determines that vehicle 2 is turning to the left, and while vehicle 2 is turning to the left, display 82 displays second portion 88 (FIG. 8B) so that the inside wheel (i.e., front left ground engaging member 4) can be viewed by the operator of the vehicle while turning. In another embodiment, controller 98 determines that vehicle 2 is turning to the right, and while vehicle 2 is turning to the right, display 82 displays third portion 90 (FIG. 8C) so that the inside wheel (i.e., front right ground engaging member 6) can be viewed by the operator of the vehicle while turning.

In another embodiment, controller 98 is configured to determine that vehicle 2 is experiencing a landing event. In various embodiments, controller 98 is configured to determine that vehicle 2 is experiencing a landing event based upon both shock absorbers being compressed between frame 12 and front suspension 48 between front left ground engaging member 4 and front right ground engaging member 6. In various embodiments, controller 98 is configured to determine that vehicle 2 is experiencing a landing event based upon a rapid change in vertical acceleration detected by accelerometer 136 or IMU 138. That is, if the vertical acceleration detected by accelerometer 136 or IMU 138 is a first negative acceleration value (indicative of a free-fall), and the controller 98 detects a second acceleration value, after the first negative value, that is greater than the first negative acceleration value, controller 98 may determine that vehicle 2 is landing. In various embodiments, if controller 98 determines that vehicle 2 is in—or just before—a landing event, display 82 may be configured to display first portion 84 so that an operator of vehicle 2 may see directly in front of vehicle 2 during and after the landing event.

In another embodiment, controller 98 may determine that vehicle 2 is traversing rocky terrain. In various embodiments, controller 98 is configured to determine that one of the front left or front right shock absorbers are in a compressed position, or controller 98 is configured to determine a difference in height between the front left and front right shock absorbers. If controller 98 determines that the vehicle speed 118 is less than a threshold value (e.g., 5 mph) and that either the front left or front right shock absorber is in a compressed position or the difference in height between the front left and front right shock absorber is greater than a threshold value, controller 98 may determine that vehicle 2 is actively traversing rocks, or other undulating terrain. In various embodiments, if vehicle 2 determines that vehicle 2 is traversing a rocky terrain, display 82 may be configured to display either second portion 88 or third portion 90. In various embodiments, display 82 may be configured to display the respective portion (i.e., second portion 88 or third portion 90) related to the compressed shock absorber. That is, if controller 98 determines that front left shock absorber adjacent front left ground engaging member 4 is in a compressed position and vehicle speed 118 is less than a threshold value, display 82 may display second portion 88 to display front left ground engaging member 4 so that an operator of vehicle 2 can better view and better place, or steer, front left ground engaging member 4 when navigating rocky terrain. In another embodiment, if controller 98 determines that front right shock absorber adjacent front right ground engaging member 6 is in a compressed position and vehicle speed 118 is less than a threshold value, display 82 may display third portion 90 to display front right ground engaging member 6 so that an operator of vehicle 2 can better view and better place, or steer, front right ground engaging member 6 when navigating rocky terrain.

In embodiments, a user may manually select which portion (e.g., first portion 84, second portion 88, third portion 90) to view at any time. A user may manually select which portion is viewed via user input 92. In various embodiments, display 82 is a touch screen, and a user may swipe left and right between first portion 84, second portion 88, and third portion 90. In various embodiments, a user may zoom in and out on each portion of viewing area 86 on display 82 by completing a user input or a pinch, for example.

### Antenna Hub

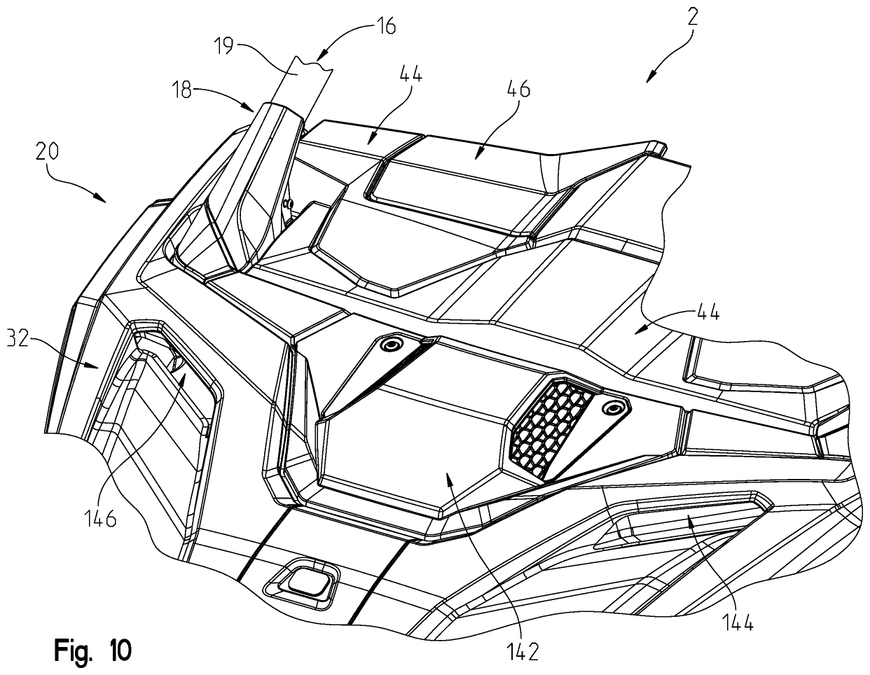

Now referring to FIGS. 10-12, body assembly 30 comprises hood 32, an intake panel 142, dashboard 44, and storage box assembly 46 generally forward of operator area 26. In embodiments, each of hood 32, intake panel 142, dashboard 44, and storage box assembly 46 are individual pieces and/or assemblies. In embodiments, one or more of hood 32, intake panel 142, dashboard 44 and storage box assembly 46 are combined to reduce the number of pieces and/or assemblies. In embodiments, hood 32 is removable from front frame portion 20 separate and independent from intake panel 142. In embodiments, one or more of hood 32, intake panel 142, dashboard 44 and storage box assembly 46 are made of a plastic material.

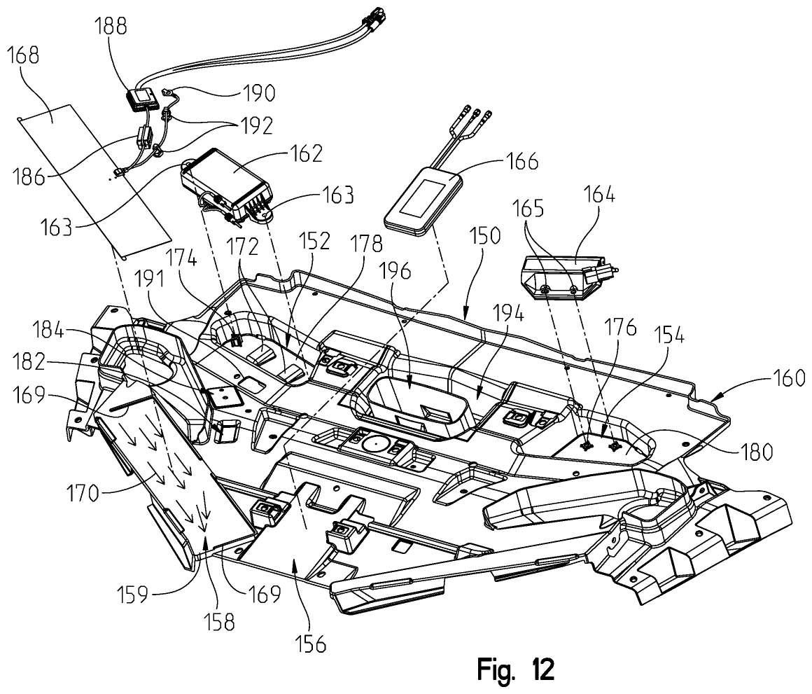

Referring to FIGS. 11-12, a panel 150 is positioned vertically beneath hood 32. In embodiments, panel 150 is positioned vertically below hood 32, intake panel 142 and at least a portion of dashboard 44. In embodiments, panel 150 is configured to be vertically above a water fording line 148 (FIGS. 3A-3B) so that in the event vehicle 2 goes through water, panel 150 stays dry and components (as described below) continue working. Panel 150 comprises a floor 151 and a panel perimeter 160 defined by an outer edge, or boundary, of panel 150. In embodiments, a lip 161 surrounds a portion of panel perimeter 160. In embodiments, lip 161 surrounds a majority of, or all of, panel perimeter 160. Panel 150 comprises a first recess, or first receiving portion 152, a second recess, or second receiving portion 154, a third receiving portion 156, and a fourth receiving portion 158. In embodiments, each of first receiving portion 152, second receiving portion 154, third receiving portion 156, and fourth receiving portion 158 are configured to receive a portion of an electrical system, or a communication system. That is, in embodiments, first receiving portion 152 is configured to receive a first antenna 162, second receiving portion 154 is configured to receive a second antenna 164, third receiving portion 156 is configured to receive a third antenna 166, and fourth receiving portion 158 is configured to receive a fourth antenna 168. In embodiments, first antenna 162 is a high frequency antenna configured for vehicle-to-vehicle communication, long-range communication, or GPS communication. In embodiments, second antenna 164 is a cellular antenna configured for communication with network 112. In embodiments, third antenna 166 is a global positioning system (GPS) antenna for determining the position of vehicle 2. In embodiments, fourth antenna 168 is an AM/FM antenna configured to communicate over radio network 116.

Still referring to FIGS. 11-12, first antenna 162 is configured to sit within first recess 152. First recess 152 comprises a plurality of standoffs 172 and a plurality of threaded standoffs 174 positioned on a bottom surface, or floor of first recess 152. First antenna 162 is configured to sit on standoffs 172 and a plurality of fasteners (not shown) are configured to couple first antenna 162 to panel 150 by passing through a pair of apertures 163 of the first antenna 162 to engage threaded standoffs 174. In embodiments, first recess 152 and standoffs 172 are dimensioned so that when first antenna 162 sits on standoffs 172, an upper surface of first antenna 162 is approximately flush with floor 151. In embodiments, first recess 152 and standoffs 172 are dimensioned so that when first antenna 162 sits on standoffs 172, an upper surface of first antenna 162 is below floor 151.

In embodiments, second antenna 164 is configured to sit within second recess 154. In embodiments, second antenna 164 is configured to sit on a floor 180 of second recess 154. Illustratively, second antenna 164 comprises a plurality of apertures 165 configured to cooperate with a plurality of apertures 176 on floor 180 of second recess 154. That is, a plurality of fasteners (not shown) are configured to extend through apertures 165 and apertures 176 to couple second antenna 164 to second recess 154. In embodiments, second recess 154 may comprises standoffs (not shown, similar to standoffs, 172, 174 of first recess 152) and second antenna 164 may be configured to sit on the standoffs. In embodiments, second recess 154 (with or without standoffs) is dimensioned to receive second antenna 164 so that an upper surface of second antenna 164 is positioned approximately flush with, or below floor 151.

In embodiments, each of first recess 152 and second recess 154 comprise drainage holes (not shown) configured to provide a path for fluid (e.g., water), or other debris to escape each of first recess 152 and second recess 154.

Still referring to FIGS. 11-12, third receiving portion 156 is configured to receive third antenna 166 (i.e., GPS) and third receiving portion 156 is positioned along longitudinal centerline L at a generally forward extent of panel 150. That is, third antenna 166 is positioned at a generally forward extent of vehicle 2 to reduce the interference from frame 12 or other components that may interfere with the signal of GPS (e.g., metal components). Third receiving portion 156 is generally a flat surface configured to receive third antenna 166. In embodiments, third receiving portion 156 is positioned higher than floor 151 to position third antenna 166 up and away from other components on panel 150. In embodiments, panel 150, hood 32, intake panel 143 and dashboard 44 may be made of a plastic material to reduce interference with any of first antenna 162, second antenna 164, third antenna 166, and fourth antenna 168.

Fourth receiving portion 158 is a generally flat surface and includes a lip 169 surrounding a portion of, or all of a perimeter of fourth receiving portion 158. Fourth antenna 168 is a film antenna configured to fit in fourth receiving portion 158 within the perimeter of lip 169. As best shown in FIG. 12, fourth receiving portion 158 comprises a slope, or gradient 170, as illustrated by arrows 170. Gradient 170 is configured to direct any fluid that passes or accumulates on fourth receiving portion 158 towards an opening 159 in the lip 169 to provide a path for fluid (e.g., water) so fluid does not accumulate in fourth receiving portion 158 or on fourth antenna 168.

In embodiments, each of first antenna 162, second antenna 164, third antenna 166, and fourth antenna 168 are operably coupled to communication bus 110. In embodiments, a ferrite bead 186 is operably coupled between fourth antenna 168 and communication bus 110 to assist in reducing interference and a low noise amplifier 188 is operably coupled between fourth antenna 168 and communication bus 110. In embodiments, a ground wire is coupled between fourth antenna 168 and the frame 12 to provide a grounded path for electrical current. Further, one or more clips 192 may be coupled to panel 150 to provide a routing path for electrical cables going to and from any of first antenna 162, second antenna 164, third antenna 166, and fourth antenna 168. In embodiments, each of first antenna 162, second antenna 164, third antenna 166, and fourth antenna 168 are positioned within perimeter 160 of panel 150. Further, in embodiments, each of first antenna 162, second antenna 164, third antenna 166, and fourth antenna 168 are positioned forward of upper frame portion 16. In embodiments, only third antenna 166 and fourth antenna 168 are positioned forward of upper frame portion. In embodiments, each of first antenna 162, second antenna 164, third antenna 166, and fourth antenna 168 are positioned laterally between upstanding frame member 17 and upstanding frame member 19.

Still referring to FIGS. 11-12, panel 150 comprises an aperture 194 and a portion of powertrain 52 is configured to extend through aperture 194. In embodiments, a conduit 196 is fluidly coupled to air inlet 58 and conduit 196 extends through aperture 194. In embodiments, conduit 196 is positioned vertically below intake panel 142, and air is configured to pass through intake panel 142 and pass into conduit 196 and flow on toward, and into, CVT 56. In embodiments, aperture 194 is positioned laterally intermediate first recess 152 and second recess 154. In embodiments, aperture 194 is positioned along longitudinal centerline L.

Referring again to FIG. 10, hood 32 of body assembly 30 comprises a first inlet 144 and a second inlet 146. In embodiments, inlets 144, 146 are angled along, and positioned on, a contour of hood 32. In embodiments, inlets 144, 146 are laterally aligned, and positioned longitudinally forward of a portion of intake panel 142. Referring now to FIGS. 11-12, inlet 144 is fluidly coupled to an air chamber 198 and inlet 146 is fluidly coupled to an air chamber 200.

Air chamber 198 comprises a floor 202 and a wall 204 surrounding a portion of floor 202. Wall 204 is configured to extend between floor 202 and hood 32 when hood 32 is positioned on top of panel 150 so that a first channel 206 is created between panel 150 and hood 32. An aperture 208 is positioned within first channel 206 along floor 202, and aperture 208 is configured to extend vertically through panel 150. Similarly, air chamber 200 comprises a floor 210 and a wall 212 surrounding a portion of floor 210. Wall 212 is configured to extend between floor 210 and hood 32 when hood 32 is positioned on top of panel 150 so that a second channel 214 is created between panel 150 and hood 32. An aperture 216 is positioned within second channel 214 along floor 210, and aperture 216 is configured to extend vertically through panel 150. In embodiments, channels 206, 214 are symmetrical about longitudinal centerline L. Illustratively, wall 204 of air chamber 198 comprises a back wall 205 that extends rearwardly and outwardly at an oblique angle relative to longitudinal centerline L. Similarly, wall 212 of air chamber 200 comprises a back wall 213 that extends rearwardly and outwardly at an oblique angle relative to longitudinal centerline L. As such, air is configured to enter air chambers 198, 200 through inlets 144, 146, respectively, and travel through channels 206, 214, and down through apertures 208, 216. Back walls 205, 213 are configured to guide air toward apertures 208, 216 without stopping or drastically reducing the velocity of the air coming into chambers 198, 200. As vehicle 2 travels at any vehicle speed, airflow will increase through chambers 198, 200 and pressure within chambers 198, 200 may increase, which may increase the flow of air out of apertures 208, 216. In embodiments, inlet 144 generally creates an inlet portion to chamber 198, inlet 146 creates an inlet portion to chamber 200, aperture 208 creates an outlet portion from chamber 198 and aperture 216 creates an outlet portion from chamber 200.

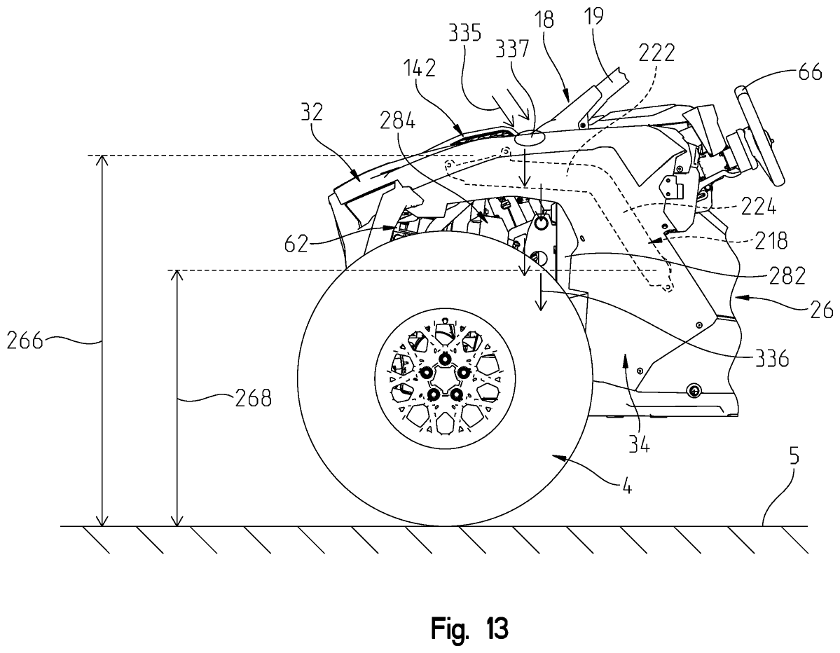

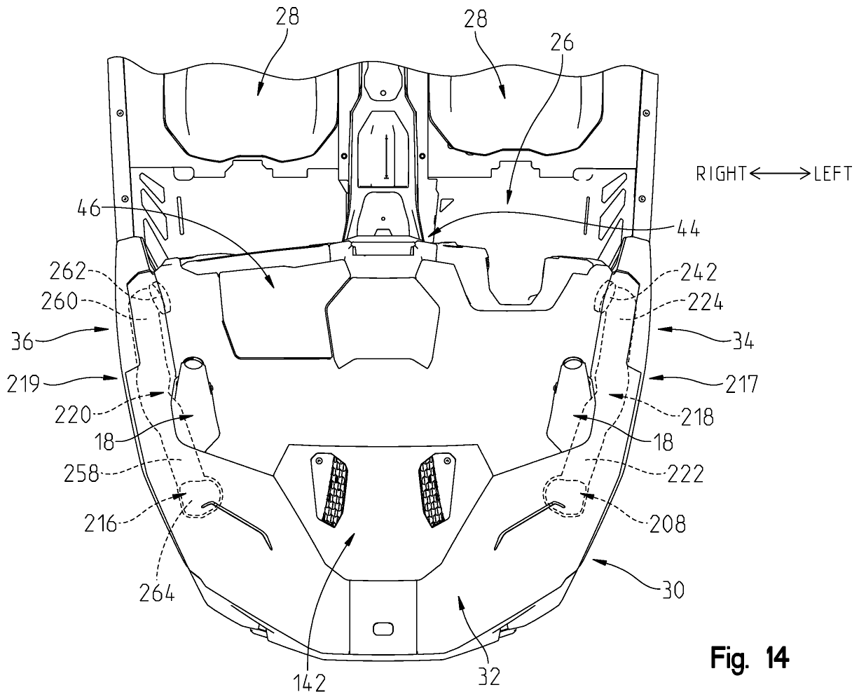

Now referring to FIGS. 13-17, a first air duct 218 is fluidly coupled between air chamber 198 and operator area 26 and a second air duct 220 is fluidly coupled between air chamber 200 and operator area 26. Illustratively, as best seen in FIG. 14, first air duct 218 extends generally along a left-side of vehicle 2 and second air duct 220 extends generally along a right-side of vehicle 2. In embodiments, each of first air duct 218 and second air duct 220 are generally positioned vertically underneath hood 32 and dashboard 44. In embodiments, air is configured to flow into chambers 198, 200 and through apertures 208, 216, respectively, and flow into air ducts 218, 220.

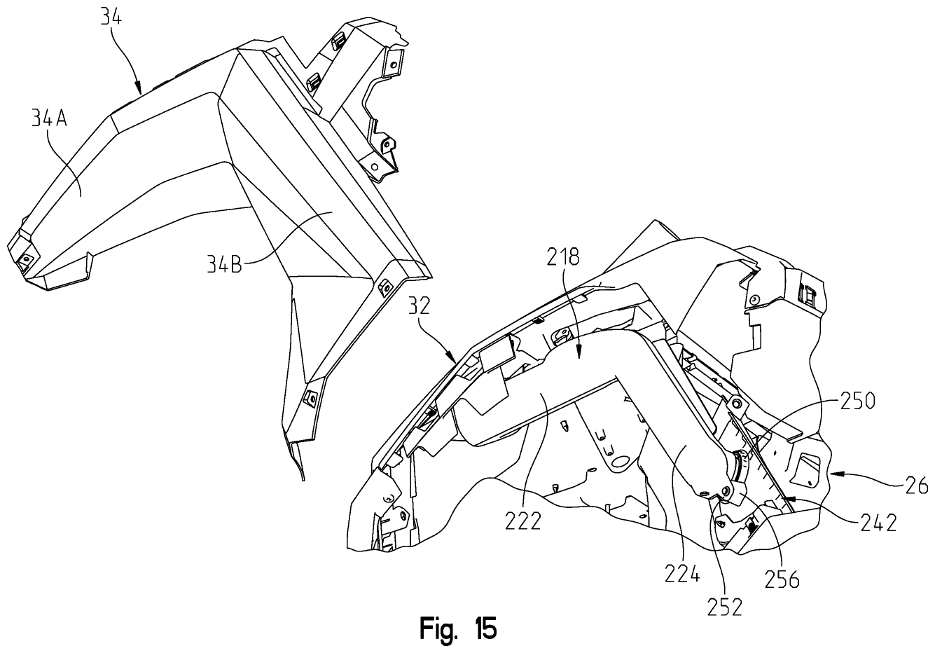

First air duct 218 comprises a first portion 222 and a second portion 224. First portion 222 is configured to couple to aperture 208 and extend generally horizontally and rearwardly and second portion 224 is configured to extend downwardly and rearwardly from first portion 222 to a body panel 242. In embodiments, body panel 242 is facing generally inwardly toward operator area 26. In embodiments, body panel 242 is positioned adjacent where an operator's feet may be. In embodiments, body panel 242 is positioned adjacent a throttle input (not shown, e.g., accelerator pedal), a brake input (not shown, e.g., brake pedal), or a clutch input (not shown, e.g., clutch pedal). In embodiments, body panel 242 is positioned vertically below dashboard 44. In embodiments, body panel 242 is positioned below steering input 66. In embodiments, body panel 242 is positioned forward of the at least one seat 28. As best seen in FIG. 15, first air duct 218 is positioned behind front left fender 34. In embodiments, front left fender 34 comprises a first portion 34A and a second portion 34B. First portion 34A extends generally horizontally and rearwardly and second portion 34B extends generally rearwardly and downwardly from first portion 34A. That is, first air duct 218 is configured to generally mirror the shape of front left fender 34 so that it may fit behind the front left fender 34. First air duct 218 mirrors the shape of front left fender 34 to make the presence of first air duct 218 less viewable, or unviewable, thereby increasing the aesthetic appeal of the first air duct.

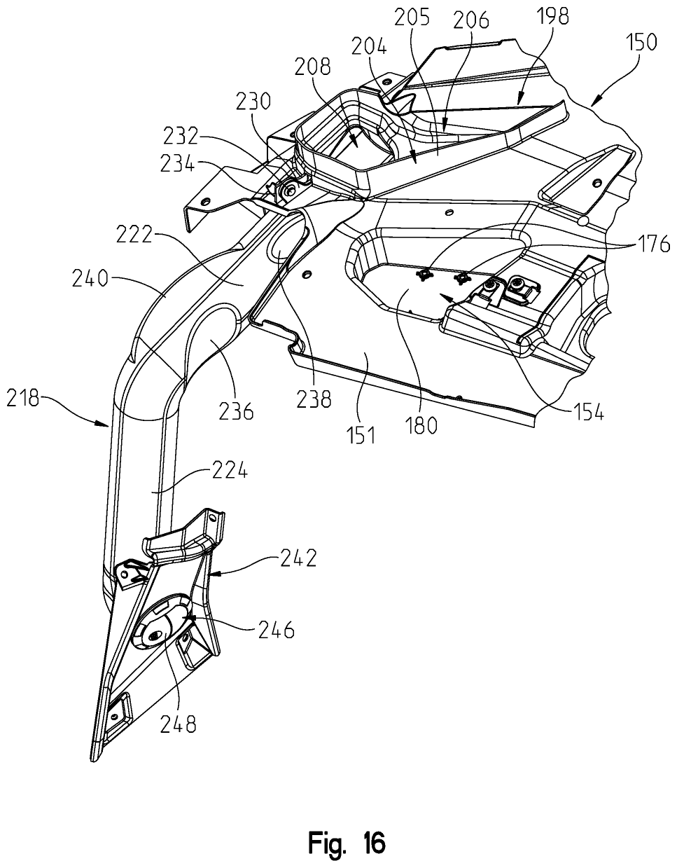

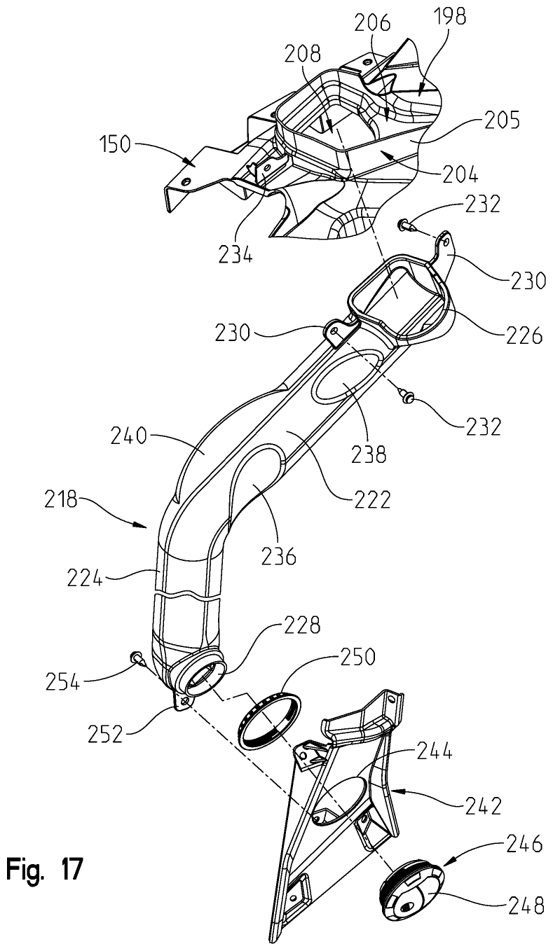

Referring now to FIGS. 16-17, first air duct 218 is operably coupled to panel 150. First air duct 218 comprises an aperture 226 configured to cooperate with aperture 208 when first air duct 218 is coupled to panel 150. That is, a pair of tabs 230 are positioned adjacent aperture 226 and are configured to cooperate with tabs 234 positioned adjacent air chamber 198. A plurality of fasteners 232 are configured to extend through apertures in each of tabs 230 and 234 to couple first air duct 218 to panel 150. In embodiments, a seal (not shown) is coupled between aperture 226 and aperture 208. In embodiments, first air duct 218 comprises a generally uniform cross-section (e.g., circular or ovular). In embodiments, first air duct 218 comprises a plurality of additional features, such as a cut-out 236, cut-out 238, or extension 240. Features 236, 238, 240 may be provided so that air duct 218 cooperates with other portions of vehicle 2, such as frame 12, front left fender 34, hood 32, or other components.

Still referring to FIGS. 16-17, first air duct 218 comprises an aperture 228 positioned at its lower and rearward position and configured to cooperate with body panel 242. Illustratively, body panel 242 comprises an aperture 244, and aperture 228 is configured to cooperate with aperture 244. A vent 246 is configured to extend through aperture 244 and cooperate with aperture 228 of first air duct 218. In embodiments, a seal (not shown) is positioned between vent 246 and aperture 228. First air duct 218 also comprises a tab 252 configured to couple with an extension 256 positioned on body panel 242. In embodiments, air is configured to flow through first air duct 218, through vent 246 and into operator area 26. That is, first air duct 218 is fluidly coupled to first inlet 144, and air is configured to flow through a first passageway 217 defined by each of first inlet 144, air chamber 198, first air duct 218, and vent 246. Air is configured to flow into first inlet 144 and into air chamber 198, through aperture 208 and into first air duct 218 and through vent 246 into operator area 26. Air duct 218 is configured to carry fresh air from a forward portion of vehicle 2 into operator area 26 to condition the air within operator area 26. In embodiments, vehicle 2 comprises a cab (not shown) configured to seal, or partially seal, the operator area 26 from the outside environment, and fresh air is configured to pass through air chamber 198 and air duct 218, into operator area 26, and create a pressurized cab environment. A pressurized cab environment may reduce the amount of air, dust, and particulates that can penetrate smaller cracks in seals, openings, or otherwise, which can assist in creating a cleaner environment within operator area 26. In embodiments, a filter (not shown) is positioned along first inlet 144 to decrease debris, dust, fluid, or other particulates that may otherwise pass through first inlet 144. In embodiments, a filter (not shown) is positioned within air chamber 198, at aperture 208, along air duct 218, or at vent 246. In embodiments, inlet 144 is positioned at a first vertical height 266 from a ground surface 5 and vent 246 is positioned at a second vertical height 268 from ground surface 5 and the first vertical height 266 is greater than the second vertical height 268.

In embodiments, vent 246 comprises one or more louvered doors 248 which may control how much air flow may go through vent 246. In embodiments, louvered doors 248 may close vent 246, open vent 246, or partially open vent 246 to any position between open and close. In embodiments, the amount of air that may flow through vent 246 may be controlled by other means, such as a single rotating disc, a closing annular vent, a baffled vent, or another type of vent. In embodiments, vent 246 is rotatable such that the direction of air flowing through vent 246 may be altered. In embodiments, vent 246 may be controlled manually by hand. In embodiments, vent 246 may be controlled by a mechanical linkage, an electric motor, or a combination thereof.

Still referring to FIGS. 13-17, air is configured to pass through second passageway 219 comprised of second inlet 146, air chamber 200, second air duct 220, and a vent 262 (FIG. 14). Although not shown in detail, second air duct 220 is constructed similarly to first air duct 218. That is, second air duct 220 comprises a first portion 258 is fluidly coupled to air chamber 200 and extends generally horizontally and rearwardly from air chamber 200 and a second portion 260 extends generally rearwardly and downwardly from the first portion 258. Vent 262 is coupled to second portion 260 and fluidly couples second air duct 220 to operator area 26. Vent 262 may be the same as, or different than, vent 246. Second air duct 220 comprises an aperture 264 configured to interface with aperture 216 of chamber 200. Second passageway 219 is configured to provide fresh air between inlet 146 and operator area 26 in substantially the same way as first passageway 217 is configured to provide fresh air between inlet 144 and operator area 26.

In embodiments, a portion of the first passageway 217 and a portion of the second passageway 219 are positioned laterally outwardly of a portion of the at least one seat 28. In embodiments, a portion of the first passageway 217 and a portion of the second passageway 219 are positioned laterally outwardly of a portion of the upper frame portion 16. That is, a portion of first passageway 217 is positioned laterally outwardly from the left coupling location 18 and upstanding frame member 19 and a portion of second passageway 219 is positioned laterally outwardly from the right coupling location 18 and upstanding frame member 17. In embodiments, a fan (not shown) is positioned along either of, or both of, first passageway 217 and second passageway 219 to increase the velocity of air flowing through first passageway 217 and second passageway 219. The fan may be controlled to operate according to a vehicle speed, an engine speed, a wheel speed, or another vehicle characteristic. In embodiments, the fan may be configured to operate at a higher speed when the vehicle speed is lower to increase the amount of air flowing through the passageways 217, 219 because less air flows through the passageways 217, 219 when the vehicle speed is lower. In embodiments, when the vehicle has a first speed, the fan has a first speed, and when the vehicle has a second speed that is greater than the first speed, the fan has a second speed that is less than the first speed. In embodiments, when the vehicle has a third speed, the fan has a third speed, and when the vehicle has a fourth speed that is less than the third speed, the fan has a fourth speed that is greater than the third speed.

### Wiper Fluid Bottle

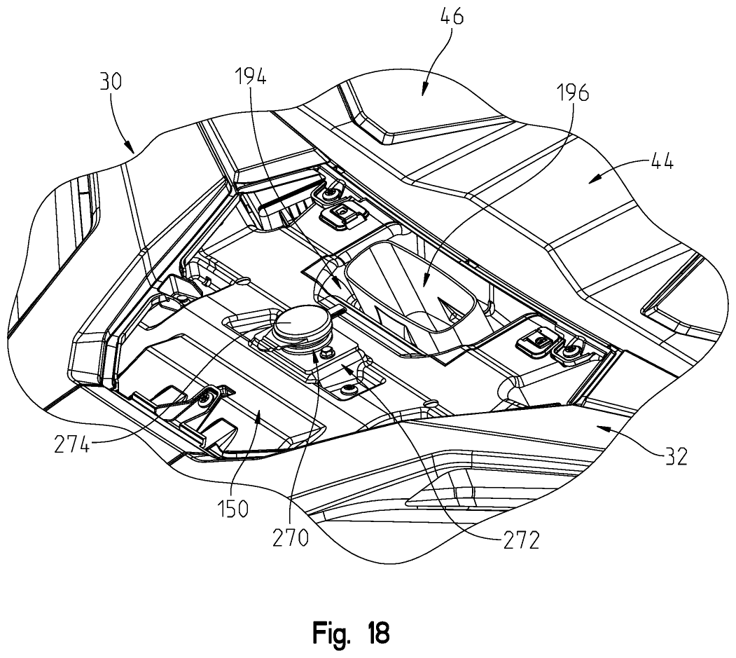

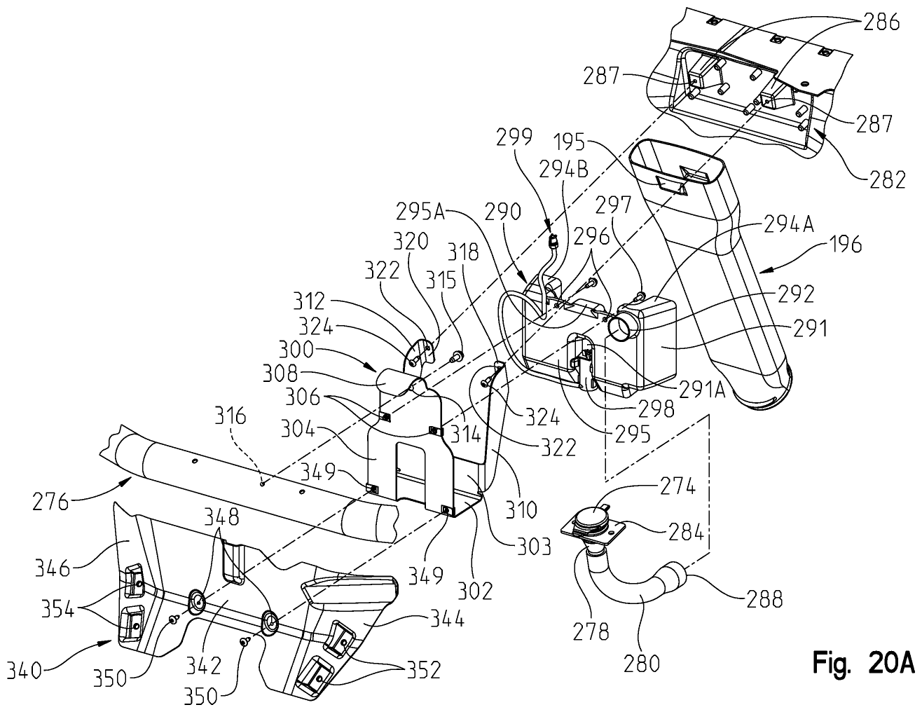

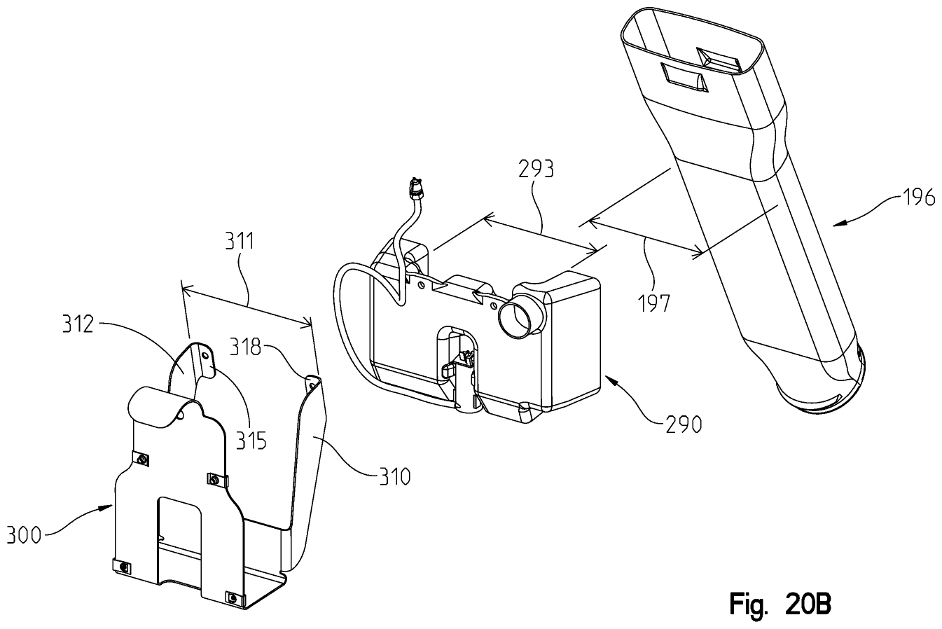

Now referring to FIGS. 18-21, panel 150 comprises an aperture 270 configured to receive a portion of bottle assembly 290 (FIG. 20). A lid 274 is configured to extend upwardly to couple to a bracket 284. In embodiments, bracket 284 is coupled to a receiving surface 272 of panel 150 positioned forward of aperture 194. Illustratively, receiving surface 272 and lid 274 are positioned underneath intake panel 142. Referring to FIGS. 19-20, bottle assembly 290 comprises a bottle 291 which includes an inlet aperture 292. A coupler 278 is fluidly coupled to lid 274 and extends below bracket 284 and has a shrinking diameter. Coupler 278 is fluidly coupled to inlet aperture 292 by a fluid conduit 280. That is, fluid may enter through lid 274, travel through coupler 278 and fluid conduit 280, pass through inlet aperture 292 and enter bottle 291. In embodiments, vehicle 2 includes a front panel 282 configured to separate operator area 26 from the front frame portion 20 and various other components supported by front frame portion (e.g., front suspension 48, steering assembly (not shown), etc.).

Bottle 291 is generally U-shaped and has a first arm 294A and a second arm 294B separated by a middle portion 295. First arm 294A and second arm 294B are separated by a first distance 293. In embodiments, conduit 196 has a first width 197 that is less than first distance 293 and conduit 196 is configured to be received between first arm 294A and second arm 294B. Conduit 196 also comprises a tab 195 positioned adjacent an upper extent thereof. Bottle 291 comprises a recess 291A configured to receive a pump 298 and pump 298 is configured to pump liquid (e.g., water or washer fluid) through a hose, or conduit 299. Middle portion 295 further comprises a tab 295A extending the same direction as arms 294A, 294B, and tab 295A is configured to receive tab 195 such that conduit 196 can couple to (i.e., sit on) tab 295A when in an assembled configuration, providing additional support. In embodiments, the interface between tabs 195, 295A is locking, or semi-permanent and may include one or more fasteners, adhesive, or interlocking mechanisms to maintain the relative position of tab 195 to tab 295A.

Still referring to FIGS. 19-20, a bracket 300 includes a base 302, a first extension 304 extending upwardly from base 302 and a second extension 303 extending upwardly from base 302 opposite first extension 304. Illustratively, bracket 300 is approximately U-shaped and configured to receive bottle assembly 290. That is, middle portion 295 of bottle 291 is configured to sit on base 302 and between second extension 303 and first extension 304. A first arm 310 extends upwardly and rearwardly from second extension 303 and away from first extension 304 and a second arm 312 extends upwardly and rearwardly from second extension 303 and away from first extension 304, opposite first arm 310. First arm 310 is separated from second arm by a distance 311, and in embodiments, distance 311 is greater than first width 197, and conduit 196 is configured to extend between, and be received between first arm 310 and second arm 312. In embodiments, distance 311 is approximately the same as first distance 293. In embodiments, first arm 310 includes a tab 318 and second arm 312 comprises a tab 320, and tabs 318, 320 extend inwardly toward each other. In embodiments, when conduit 196 is received between first arm 310 and second arm 312, each of tabs 318, 320 are configured to engage a back surface of conduit 196 to enclose and restrain conduit 196 to bracket 300. In embodiments, front panel 282 comprises a pair of standoffs 286 extending forwardly, and each standoff 286 comprises an aperture 287. Further, each of tabs 318, 320 comprise an aperture 322, and tabs 318, 320 are configured to engage with standoffs 286 positioned on front panel 282. A pair of fasteners 324 are configured to couple bracket 300 to front panel 282 by extending through apertures 322 and aperture 287.

Still referring to FIGS. 19-20, frame 12 also comprises a U-shaped frame member 276 extending laterally across vehicle 2 within front frame portion 20. Additional details regarding frame 12 and U-shaped member 276 may be found in U.S. patent application Ser. No. 17/518,733, filed Nov. 4, 2021, titled VEHICLE, attorney docket no. PLR-15-28561.04P-US, the entire disclosure of which is expressly incorporated herein by reference. In embodiments, bracket 300 comprises a hook 308 positioned at an upper extent of first extension 304 and an aperture 314 adjacent hook 308. In embodiments, U-shaped member 276 comprises an aperture 316 and hook 308 is constructed such that hook 308 may wrap around and couple to u-shaped frame member 276 and a fastener 315 may extend through aperture 314 and aperture 316 to couple bracket 300 to U-shaped member 276. In embodiments, a manufacturer may assemble bracket 300 onto vehicle 2 by placing hook 308 of bracket 300 on U-shaped member 276 so that bracket 300 is resting on U-shaped member 276, which may make it simpler to insert fastener 315 into apertures 314, 316 and fasteners 324 through apertures 322, 287, respectively.

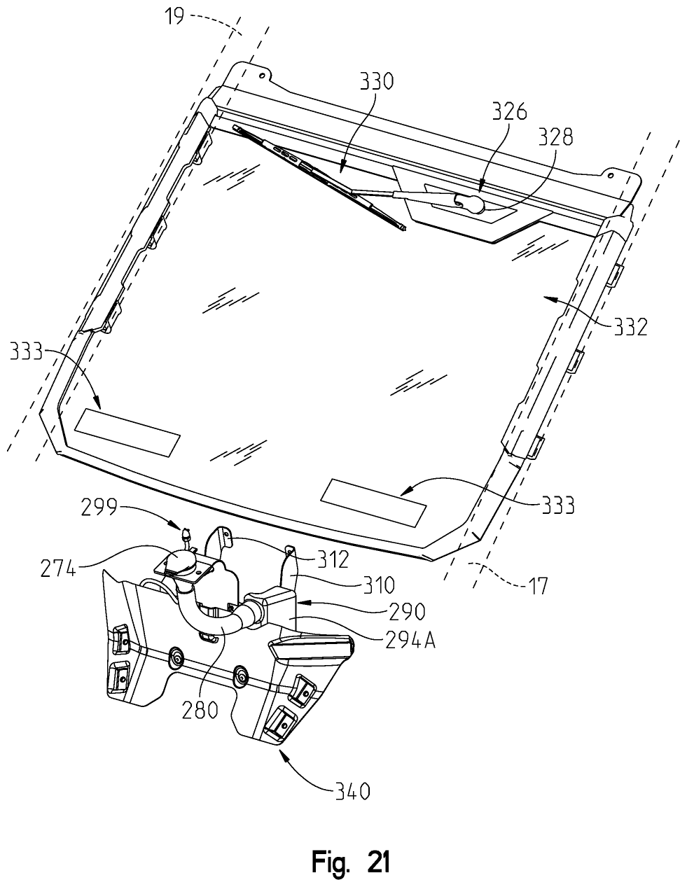

Referring now to FIG. 21, hose 299 is configured to direct fluid (e.g., water or wiper fluid) onto a windshield 332. Illustratively, windshield 332 is configured to extend between upstanding frame member 17 and upstanding frame member 19 and protect an occupant of operator area 26 from debris, fluid, or other particulates coming directly at vehicle 2. In embodiments, vehicle 2 comprises a wiper assembly 326 operably coupled to windshield 332. Wiper assembly 326 comprises a motor 328 and a wiper 330 operably coupled to the motor 328. In embodiments, a user or operator of vehicle 2 may provide an input to one or more user inputs which may activate motor 328 so that wiper 330 rotates and wipes across windshield 332. In embodiments, a user or operator of vehicle 2 may provide an input to one or more user inputs which may activate pump 298 so that fluid (e.g., water, wiper fluid) is sprayed through hose 299 onto windshield 332. In embodiments, in response to one or more user inputs, motor 328 and pump 298 are activated simultaneously, or in concert, so that fluid (e.g., water, wiper fluid) is sprayed through hose 299 onto windshield 332 while wiper 330 wipes across windshield 332 with fluid from bottle 291.

### Climate Control

In embodiments, when windshield 332 includes one or more vents 333 (FIG. 21) which are configured to allow air through into operator area 26. In embodiments, the one or more vents 333 are configured to be completely open, completely closed, or partially open at a position between open and closed (i.e., 25% open). In embodiments, vents 333 comprise sliding doors, louvered panels, or other mechanical linkages capable of opening and/or closing vents 333. In embodiments, when vehicle 2 is moving, air pressure is built up along an air path generally described by arrows 335 (FIG. 13). As air pressure increases at the base of windshield 332, air is forced through vents 333 and into operator area 26.

In embodiments, vents 333 are positioned within body assembly 30. In embodiments, vents 333 are positioned within hood 32 adjacent the base of windshield 332 such that as air pressure increases at the base of windshield 332, air is forced through vents 333 and down toward front frame portion 20.

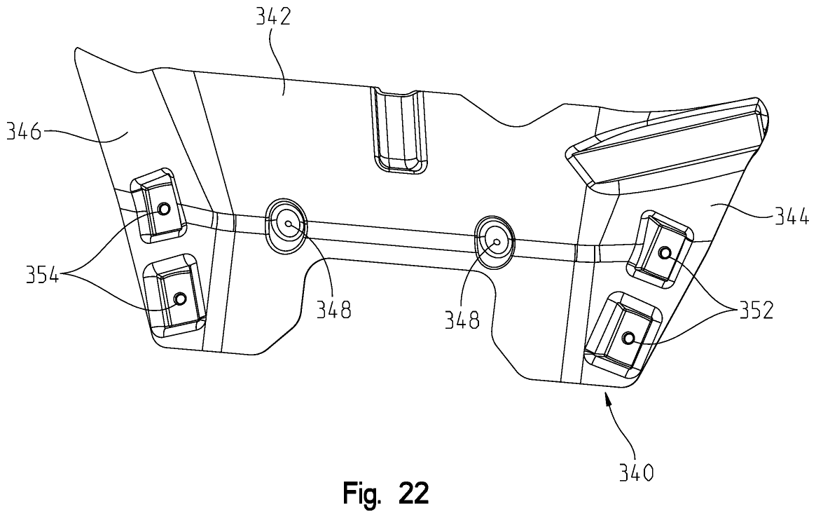

Referring now to FIGS. 19-28, vehicle 2 may include a deflector shield 340 positioned within front frame portion 20. In embodiments, deflector shield 340 is positioned along longitudinal centerline L and is configured to divert incoming air outwardly away from operator area 26 and front panel 282. In embodiments, deflector shield 340 includes a central portion 342, a first extension 344 angled rearwardly and outwardly from central portion 342, and a second extension 346 angled rearwardly and outwardly from central portion 342 opposite first extension 344. In embodiments, first extension 344 is a left extension and second extension 346 is a right extension. Central portion 342 of deflector shield 340 includes a pair of apertures 348, first extension 344 includes a pair of apertures 352, and second extension 346 includes a pair of apertures 354. In embodiments, bracket 300 includes a pair of apertures 349, and a pair of fasteners 350 extend through apertures 348, 349 to couple deflector shield 340 and bracket 300. In embodiments, a pair of fasteners 356 are configured to extend through apertures 352 and couple first extension 344 of deflector shield 340 to frame 12 of vehicle 2. In embodiments, a pair of fasteners 358 are configured to extend through apertures 354 and couple second extension 346 of deflector shield 340 to frame 12 of vehicle 2.

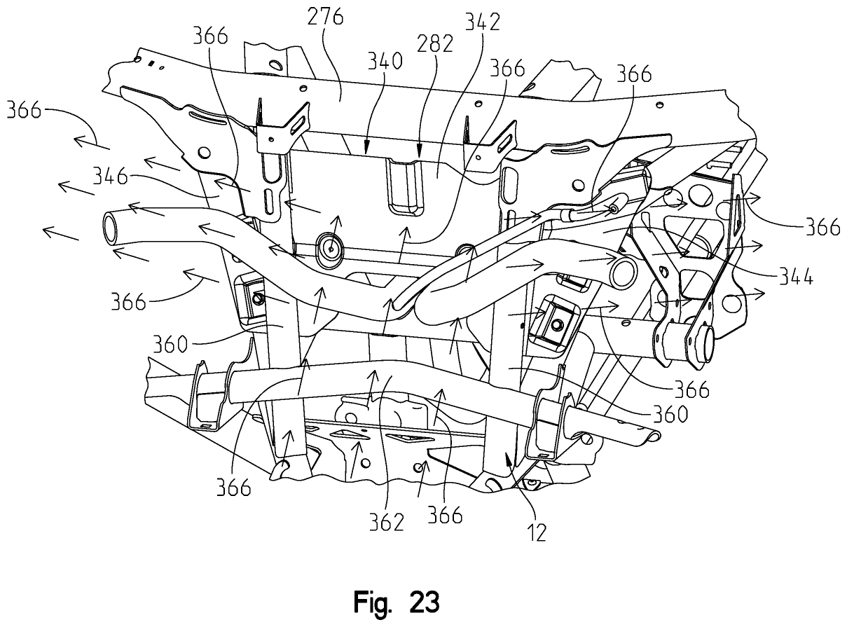

Referring now to FIG. 23-24, front frame portion 20 comprises a pair of generally vertical frame members 360 extending downwardly from U-shaped frame member 276. Further, a frame member 362 extends across each generally vertical frame member 360 at a position vertically lower than U-shaped frame member 276. In embodiments, any of frame members 276, 360, or 362 may be used to mount front suspension 48, a steering assembly (not shown), electrical components, a portion of the powertrain, or other components present in front frame portion 20.

Deflector shield 340 is positioned rearward of frame members 360, 362. As shown in FIG. 24, a fan 364 is coupled to a rear-side of heat exchanger 62. Illustratively, fan 364 is configured to pull air through heat exchanger 62 and push it rearwardly toward deflector shield 340 along path 366. In embodiments, fan 364 is coupled to a front-side of heat exchanger 62 and is configured to push air through heat exchanger 62 and push it towards deflector shield 340. In embodiments, heat exchanger 62 and fan 364 are angled rearwardly and downwardly so that a top of heat exchanger 62 is positioned more rearwardly than a bottom of heat exchanger 62. In embodiments, deflector shield 340 is positioned longitudinally intermediate heat exchanger 62 and front panel 282. In embodiments, deflector shield 340 is positioned a first distance 374 in front of, or away from, front panel 282. In embodiments, deflector shield 340 is positioned a second distance 370 behind a front extent of heat exchanger 62, a third distance 372 behind a middle of heat exchanger 62, a fourth distance 368 behind a rear extent of heat exchanger 62, a fifth distance 378 behind a middle of fan 364, and a sixth distance 376 behind a rear extent of fan 364. In embodiments, deflector shield 340 is positioned one-third the total distance between fan 364 and front panel 282 (e.g., distance 376 plus distance 374) behind the fan 364. In embodiments, deflector shield 340 is positioned between one-third and one-half the distance between fan 364 and front panel 282 (e.g., distance 376 plus distance 374). In embodiments, deflector shield 340 is positioned between one-third and two-thirds the distance between fan 364 and front panel 282 (e.g., distance 376 plus distance 374).

Fan 364 is configured to push air within an upper boundary 380 and a lower boundary 382, and in embodiments, deflector shield 340 is wholly positioned within upper boundary 380 and lower boundary 382. In embodiments, deflector shield 340 extends above a portion of upper boundary 380 and in embodiments, deflector shield 340 extends below a portion of lower boundary 382. Still referring to FIG. 24, heat exchanger 62 and fan 364 is configured to direct air at deflector shield 340. In embodiments, approximately fifty percent of the air pushed by fan 364 is configured to be directed at deflector shield 340. In embodiments, more than fifty percent of the air pushed by fan 364 is configured to be directed at deflector shield 340.

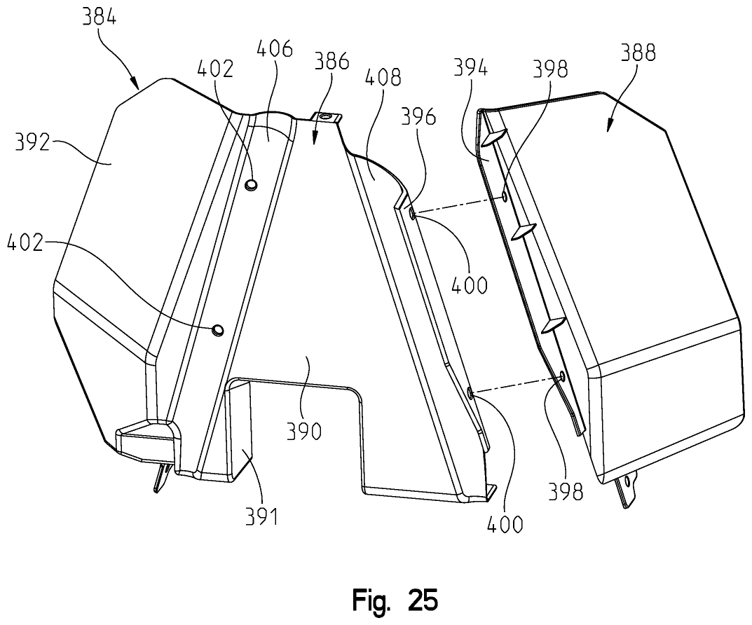

Now referring to FIGS. 25-28, an alternative deflector shield 384 includes a first shield piece 386 and a second shield piece 388. In embodiments, first shield piece 386 comprises a first flange 396 with a pair of apertures 400 and second shield piece 388 comprises a second flange 394 with a pair of apertures 398. A pair of fasteners 404 (FIG. 25) are configured to extend through apertures 398 and apertures 400 to couple first shield piece 386 and second shield piece 388. Deflector shield 384 comprises a center portion 390, a first extension 392 and second shield piece 388 is configured as a second extension. Illustratively, first extension 392 extends outwardly and rearwardly from center portion 390 toward a right side of vehicle 2, and second shield piece 388 extends outwardly and rearwardly from center portion 390 toward a left side of vehicle 2. Further, deflector shield comprises a first channel 406 and a second channel 408 that extend along the vertical height of first shield piece 386. Further, a pair of apertures 402 are positioned within first channel 406.

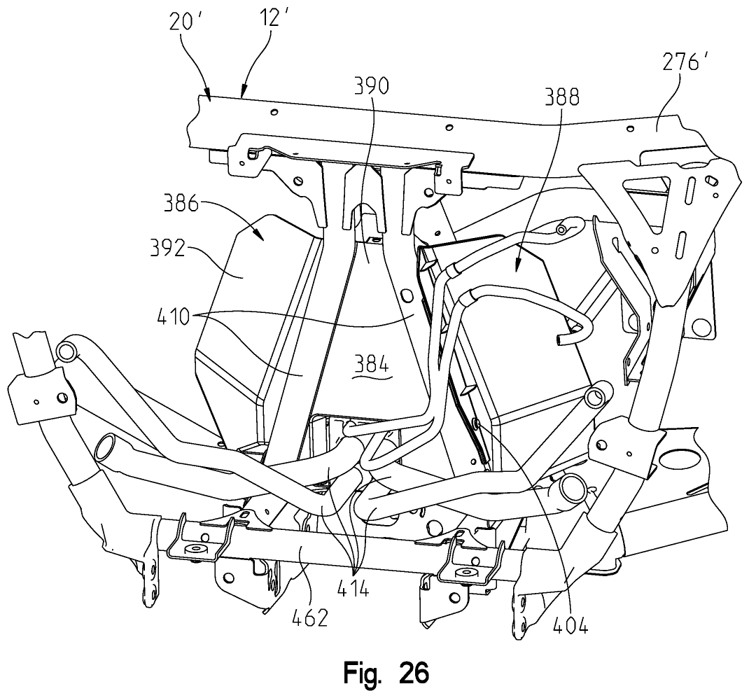

Referring to FIG. 26, vehicle 2 may comprise an alternative frame 12′ which may be substantially similar to frame 12. Frame 12′ may comprise a front frame portion 20′ which includes a U-shaped frame member 276′, each of which may be substantially similar to front frame portion 20 with U-shaped frame member 276. A frame member 412 is positioned generally vertically lower than U-shaped frame member 276 and extends upwardly to couple to U-shaped frame member 276. Further, a pair of generally upstanding members 410 are coupled between frame member 412 and U-shaped frame member 276. Illustratively, a first generally upstanding member 410 is configured to fit in first channel 406 and a second generally upstanding member 410 is configured to fit in second channel 408. That is, alternative deflector shield 384 is configured to be seated within front frame portion 20′ in a position cooperating with each of generally upstanding members 410.

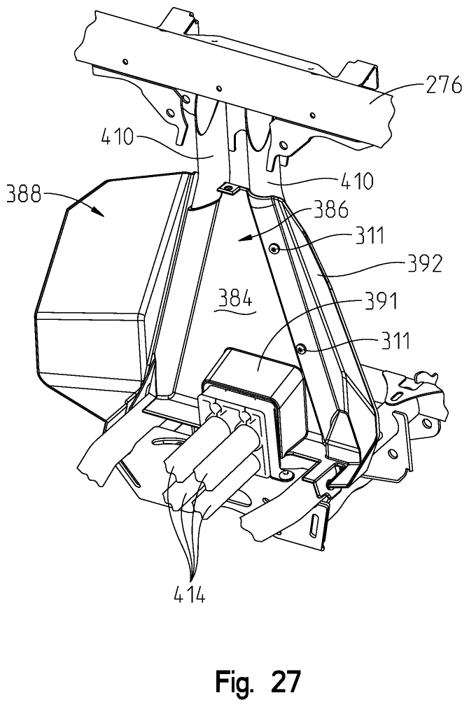

Still referring to FIGS. 25-27, alternative deflector shield 384 comprises an aperture 391 that is generally rectangular shaped. As best seen in FIGS. 26-27, a plurality of hoses 414 are configured to pass through aperture 391. Hoses 414 are configured to couple between heat exchangers 62, 64 and one or more components of the powertrain 52 (e.g., prime mover 54, intercooler, transmission, etc.).

Now referring to FIG. 28, alternative deflector shield 384 is positioned intermediate front panel 282 and each of the first heat exchanger 62 and the second heat exchanger 64. In embodiments, second heat exchanger 64 is coupled to a front-side of first heat exchanger 62 and a fan 364 is coupled to a rear-side of first heat exchanger 62. That is, first heat exchanger 62 is sandwiched between second heat exchanger 64 and fan 364. In embodiments, fan 364 is configured to pull air through each of first heat exchanger 62 and second heat exchanger 64 and push it towards alternative deflector shield 384. In embodiments, alternative deflector shield 384 is separated from front panel 282 by a first distance 416, alternative deflector shield 384 is separated from a front extent of second heat exchanger 64 by a second distance 418, and alternative deflector shield 384 is separated from a front extent of first heat exchanger 62 by a third distance 420. In embodiments, alternative deflector shield 384 is separated from a mid-point of first heat exchanger 62 by a fourth distance 422, alternative deflector shield 384 is separated from a rear extent of first heat exchanger 62 by a fifth distance 424, and alternative deflector shield 384 is separated from a rear extent of fan 364 by a sixth distance 426. In embodiments, deflector shield 384 is positioned one-third the total distance between fan 364 and front panel 282 (e.g., distance 416 plus distance 426) behind the fan 364. In embodiments, deflector shield 384 is positioned between one-third and one-half the distance between fan 364 and front panel 282 (e.g., distance 416 plus distance 426). In embodiments, deflector shield 384 is positioned between one-third and two-thirds the distance between fan 364 and front panel 282 (e.g., distance 416 plus distance 426).

Fan 364 is configured to push air within an upper boundary 428 and a lower boundary 430, and in embodiments, deflector shield 384 is wholly positioned within upper boundary 428 and lower boundary 430. In embodiments, deflector shield 384 extends above a portion of upper boundary 428 and in embodiments, deflector shield 384 extends below a portion of lower boundary 430. Still referring to FIG. 24, heat exchanger 62 and fan 364 is configured to direct air at deflector shield 384. In embodiments, approximately fifty percent of the air pushed by fan 364 is configured to be directed at deflector shield 384. In embodiments, more than fifty percent of the air pushed by fan 364 is configured to be directed at deflector shield 384. In embodiments, second heat exchanger 64 is smaller than first heat exchanger 62 and second heat exchanger has an upper bound 432 that is intermediate upper boundary 428 and lower boundary 430. In embodiments, all of second heat exchanger 64 overlaps a portion of first heat exchanger 62, and air that passes through second heat exchanger 64 also passes through first heat exchanger 62, and air that passes through each of second heat exchanger 64 and first heat exchanger 62 (i.e., between lower boundary 430 and upper bound 432, along path 434) may be warmer than air that passes only through first heat exchanger 62 (i.e., between upper boundary 428 and upper bound 432, along path 436). In embodiments, alternative deflector shield 384 is positioned so that air that passes through each of first heat exchanger 62 and second heat exchanger 64 along path 434 is directed toward alternative deflector shield 384 by fan 364. In embodiments, alternative deflector shield 384 is positioned so that air that passes through only first heat exchanger along path 436 is directed above alternative deflector shield 384 by fan 364.

In embodiments, vehicle 2 includes one or more apertures 337 (FIG. 13) positioned within hood 32 at a position adjacent windshield 332. As vehicle 2 moves forwardly, air pressure builds up adjacent apertures 337 at the junction of windshield 332 and hood 32 and air is pushed down through apertures 337. Air pushed downwardly through apertures 337 extends downwardly into front frame portion 20 at a position forwardly of front panel 282 along arrows 336 (FIG. 13). Air pushed downwardly through apertures 337 creates an air wall between first heat exchanger 62 and front panel 282. Air passes through heat exchanger 62 and is pushed rearwardly through front frame portion 20. In embodiments, air is configured to be spread laterally outwardly by either of deflector shields 340, 384 and any air that passes by deflector shields 340, 384 will be pushed downwardly by the air wall along arrows 336. In embodiments, vehicle 2 only comprises the air wall denoted by arrows 336 and air that passes through heat exchanger 62 is pushed downwardly by the air wall. In embodiments, the air wall denoted by arrows 336 reduces the heat that reaches front panel 282 and may reduce the heat that reaches operator area 26.

### Storage Box

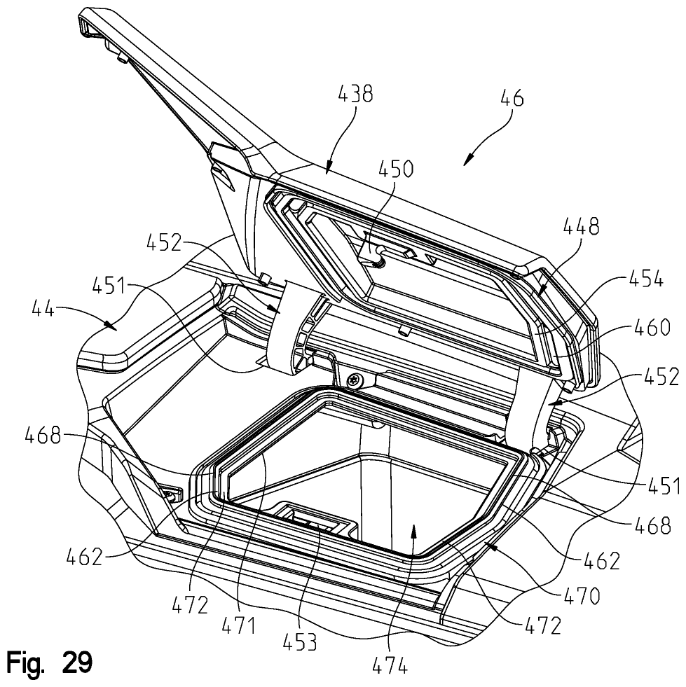

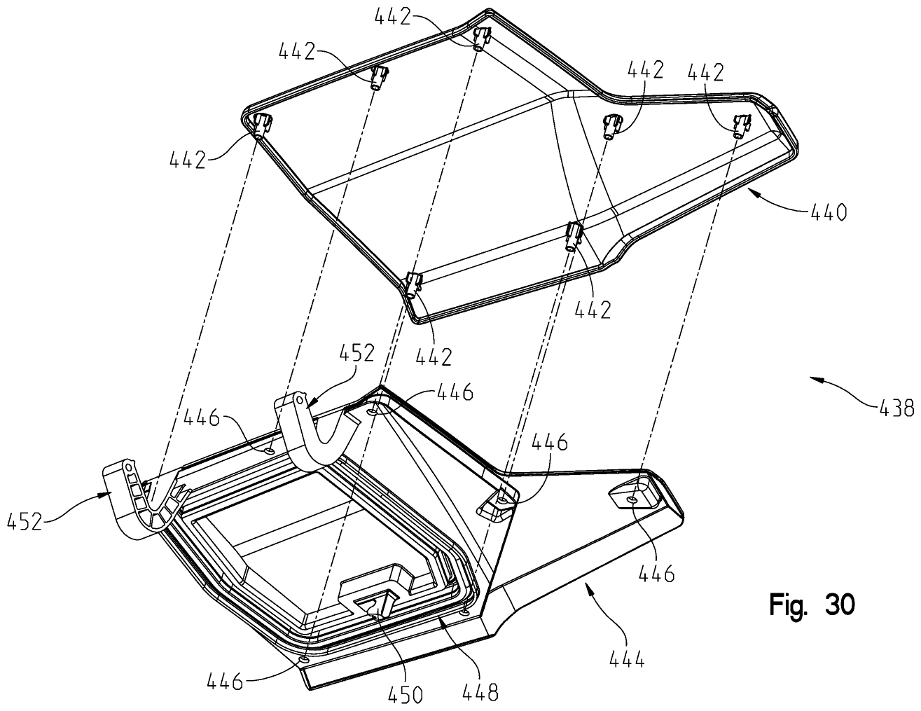

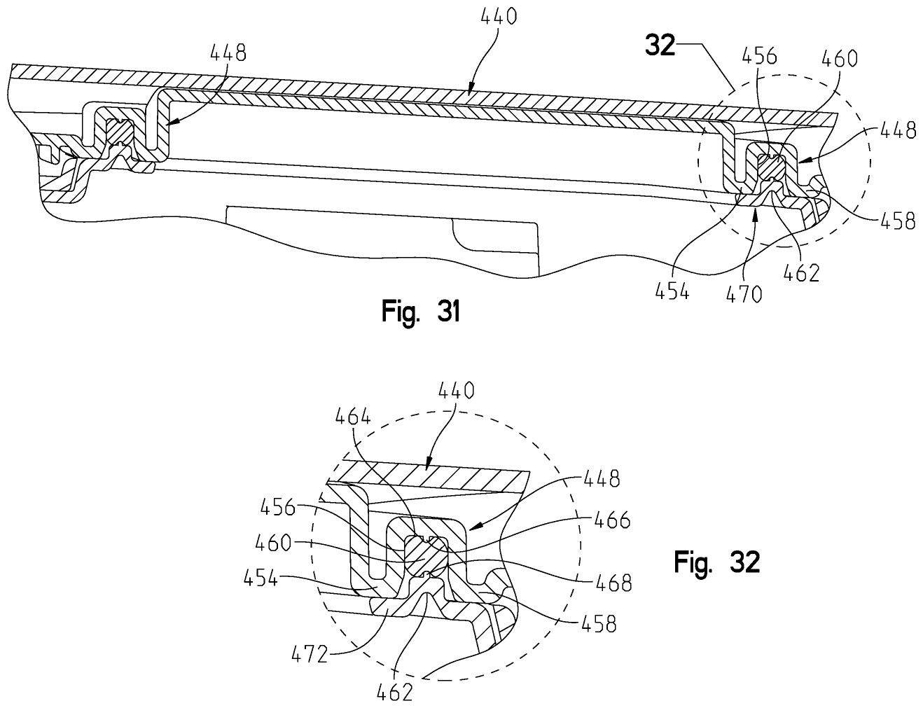

Now referring to FIGS. 29-32, storage box assembly 46 comprises a lid 438 configured to cover a storage box volume 474. Referring to FIG. 30, lid 438 comprises an outer lid 440 and an inner lid 444. Outer lid 440 is generally a single uniform piece with a plurality of standoffs 442. In embodiments, standoffs 442 are threaded. In embodiments, inner lid 444 comprises a plurality of apertures 446 configured to cooperate with standoffs 442. A plurality of fasteners (not shown) is configured to extend through apertures 446 and engage standoffs 442 to couple inner lid 444 and outer lid 440. Illustratively, outer lid 440 provides an aesthetic outer panel which may be comprised of a different material than inner lid 444. In embodiments, outer lid 440 is a similar material as dashboard 44. In embodiments, inner lid 444 is structural and is comprised of a more durable, strong material than outer lid 440. Illustratively, lid 438 is a two-part lid which provides design flexibility to create an aesthetically pleasing lid that is strong, sturdy, and may withstand repeated use and harsh environments, debris, fluid, and other contaminants.

Still referring to FIGS. 29-32, a pair of U-shaped arms 452 are coupled to inner lid 444. Dashboard 44 comprises a pair of apertures 451 and U-shaped arms 452 are configured to extend into apertures 451 and couple lid 438 to dashboard 44. Inner lid 444 also comprises an upper sealing structure 448 and a latch 450 positioned adjacent the upper sealing structure 448. Storage box volume 474 comprises an aperture 471 configured to allow ingress/egress of storage items in and out of storage box volume 474. In embodiments, aperture 471 is surrounded by a lower sealing structure, or lower frame 470.

In embodiments, upper sealing structure 448 is configured to cooperate with lower sealing structure 470. In embodiments, each of upper sealing structure 448 and lower sealing structure 470 surround aperture 471 and comprise a continuous perimeter. Upper sealing structure 448 comprises an inner wall 454, an outer wall 458, a recessed surface 464, and each of the inner wall 454, outer wall 458, and recessed surface 464 create a recess 456. Further, recessed surface 464 comprises a notch, or protrusion 466, and a seal 460 is configured to sit in the recess 456. In embodiments, seal 460 is made of rubber, plastic, foam, or another type of resilient member. In embodiments, the notch 466 extends outwardly from recessed surface 464 and engages seal 460. Lower sealing structure 470 comprises a first surface 472 and a ridge, or lip 462 extending upwardly from first surface 472, and lip 462 is configured to be received by the recess 456 when lid 438 is in a closed position. Ridge 462 comprises a notch, or protrusion 468 extending upwardly. As best shown in FIG. 32, when upper sealing structure 448 engages lower sealing structure 470 (i.e., a closed position), notch 468 is aligned with notch 466 and each of notches 466, 468 contact seal 460. Each of notch 466, 468 has a small cross-section, that is, each of notch 466, 468 has a smaller cross-section than lip 462 and seal 460. In embodiments, when notches 466, 468 engage seal 460, the pressure created between notches 466, 468 and seal 460 increases as the cross-section of notches 466, 468 decreases for a given force needed to couple upper sealing portion 448 of lid 438 onto lower sealing structure 470. That is, a high amount of pressure (i.e., pounds per square inch (psi)) may be created between upper sealing portion 448 and lower sealing portion 470 by reducing the cross-section of notches 466, 468, thereby decreasing the amount of force a user may need to close lid 438 of storage box assembly 46.

In embodiments, lower sealing structure 470 comprises a latch receiver 453 positioned within aperture 471. Latch receiver 453 is configured to receive latch 450 to lock or unlock storage box assembly 46. In embodiments, latch 450 is configured to only couple lid 438 to lower sealing structure 470. Further, in embodiments, storage box assembly 46 is a sealed storage container and configured to prevent fluid (e.g., water, other fluids or debris) from entering storage box volume 474.

### Speaker

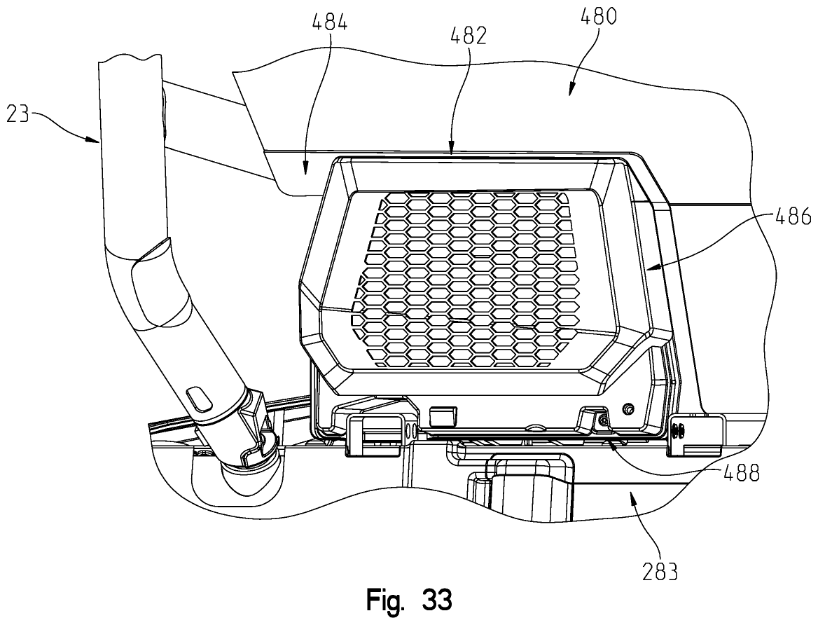

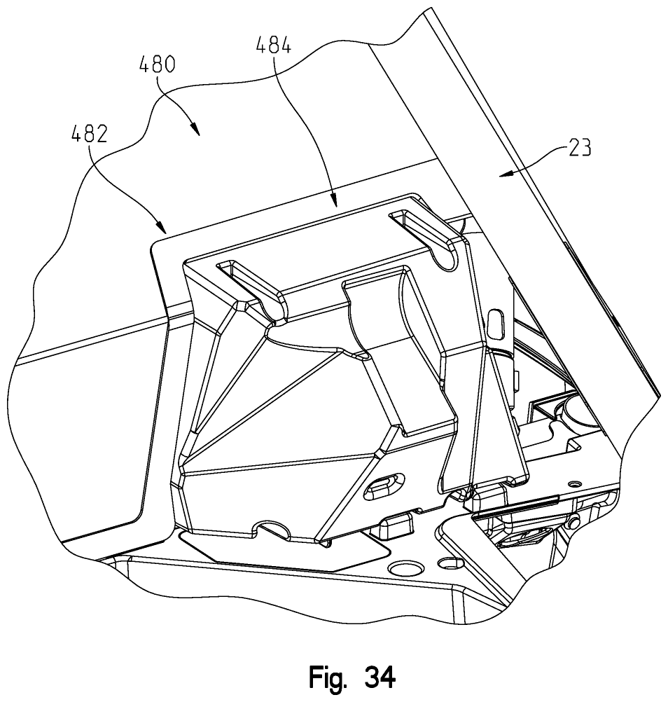

Now referring to FIGS. 33-35, a rear windshield 480 is configured to extend between upstanding frame member 21 and upstanding frame member 23 at a position rearward of operator area 26. Rear windshield 480 may be configured to reduce wind intrusion, debris intrusion, fluid intrusion, or the like, into operator area 26. In embodiments, rear windshield 480 comprises a slot 482 configured to receive a speaker 486. In embodiments, speaker 486 is generally square (i.e., straight edges) and slot 482 is configured with a shape corresponding to the profile of speaker 486. In embodiments, rear windshield 480 comprises an edge 484 positioned along slot 482. In embodiments, edge 484 extends obliquely relative to rear windshield 480 and is configured to profile to speaker 486. Speaker 486 is configured to couple to an upper extent of rear panel 283 and direct sound into operator area 26. In embodiments, a pair of speakers 486 are coupled to an upper extent of rear panel 283, that is, a first speaker 486 is coupled to an upper extent of rear panel 283 adjacent upstanding frame member 21 and a second speaker 486 is coupled to an upper extent of rear panel 283 adjacent upstanding frame member 23. Further, in embodiments, a seal (not shown) is configured to couple to edge 484 and seal the interface between speaker 486 and rear windshield 480. In embodiments, rear windshield 480 may comprise a plurality of shape configurations to accommodate a single speaker 486, a pair of speakers 486, three speakers 486, or more speakers.

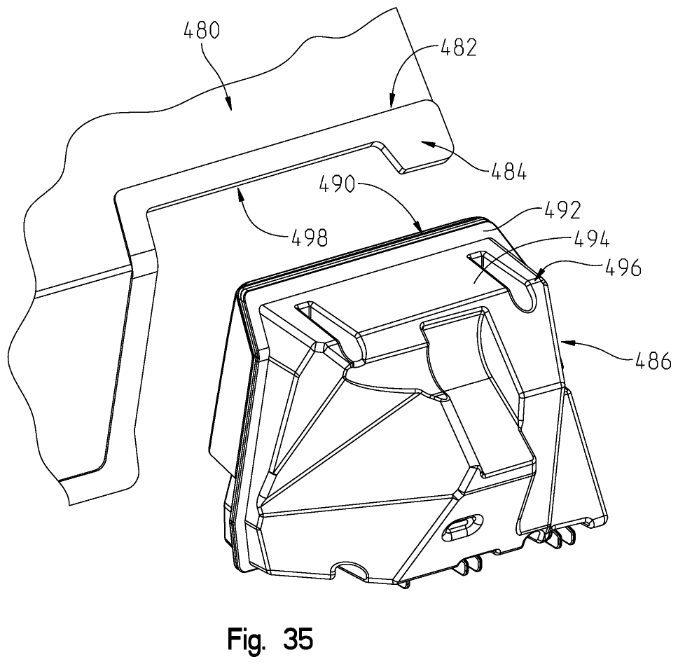

Referring now to FIG. 35, speaker 486 comprises an upper surface 494, a lip 490 extending upwardly from upper surface 494, and a surface 492 extending between lip 490 and upper surface 494. In embodiments, edge 484 is angled to cooperate with, and extend parallel to surface 492. In embodiments, edge 484 comprises a profile 498 that is configured to cooperate with a profile 496 of upper surface 494 (e.g., profile 498 comprises jogs, slots, protrusions and the like configured to cooperate with jogs, slots, protrusions and the like of profile 496 of upper surface 494. In embodiments, each of lip 490, surface 492, and upper surface 494 cooperate with edge 484 to create a seal between rear windshield 480 and speaker 486.

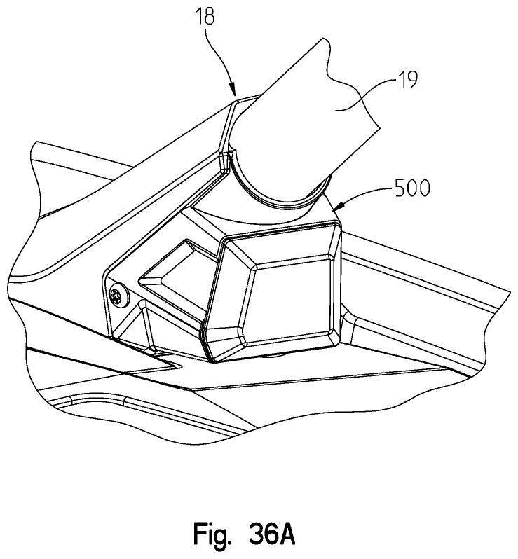

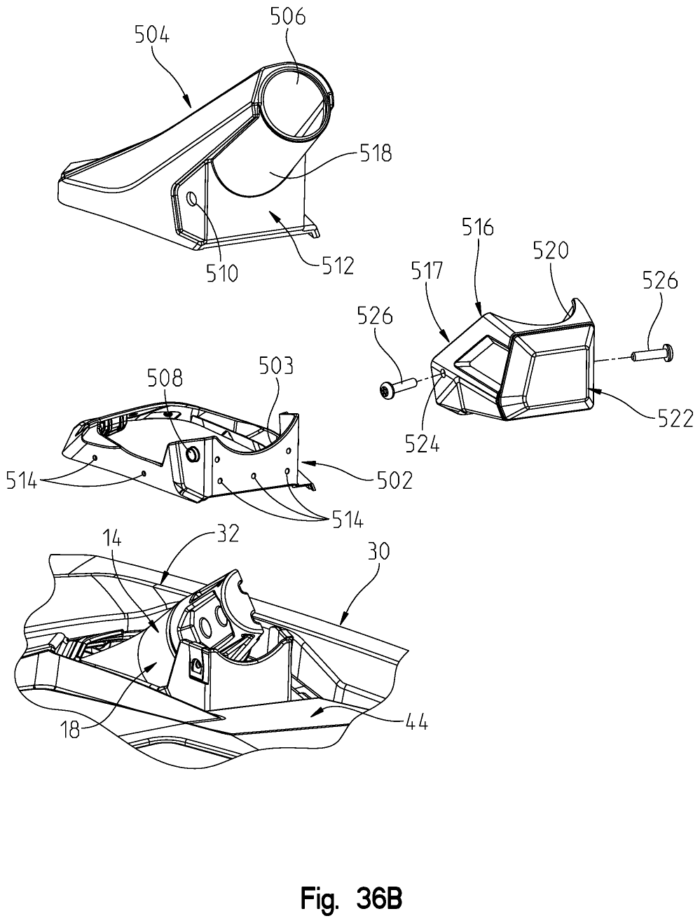

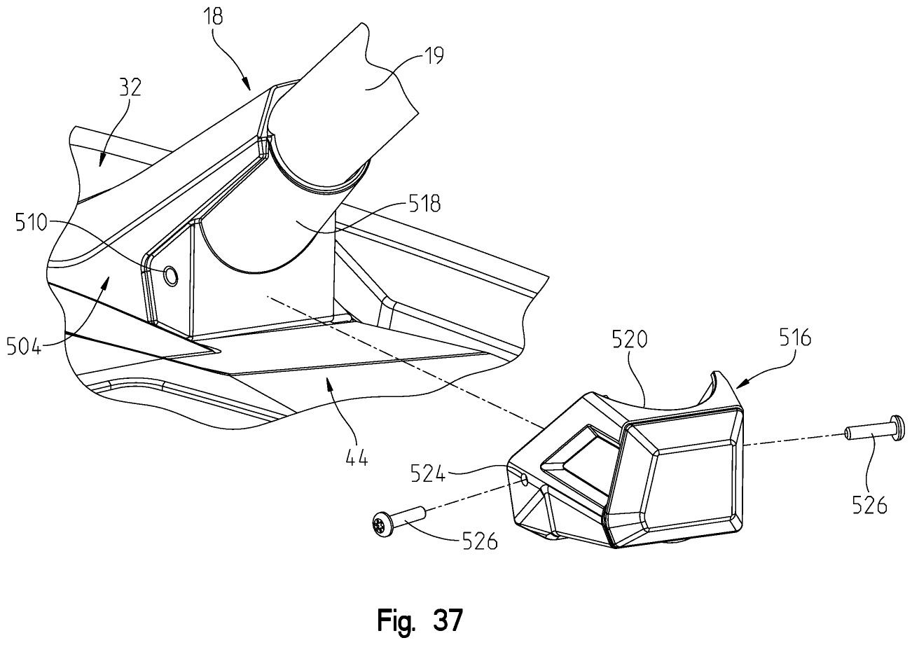

Referring now to FIGS. 36A-37, a speaker assembly 500 is positioned at front coupling locations 18 between lower frame portion 14 and upper frame portion 16. In embodiments, a first speaker assembly 500 is positioned at front coupling locations 18 adjacent upstanding frame member 17 and a second speaker assembly 500 is positioned at front coupling locations 18 adjacent upstanding frame member 19. In embodiments, speaker assembly 500 comprises a base 502, a cover 504, and a speaker 516. Base 502 is configured to fit within body assembly 30, around front coupling locations 18. In embodiments, base 502 comprises a first arcuate slot 503 configured to support a portion of either of upstanding frame member 17 or upstanding frame member 19. Further, in embodiments, base 502 comprises a pair of apertures 508. Cover 504 comprises an arcuate (or circular) extension 518 comprising a first opening 506 configured to receive either of upstanding frame member 17 or upstanding frame member 19 such that upstanding frame member 17 or upstanding frame member 19 extend through cover 504 to couple with lower frame portion 14. Further, cover 504 comprises a receiving portion 512 positioned vertically below extension 518. In embodiments, a pair of apertures 510 are positioned within receiving portion 512. In embodiments, cover 504 is overmolded onto base 502, and base 502 comprises a plurality of coupling points 514 configured to receive the overmolded material of cover 504. That is, during the manufacturing process, base 502 may be overmolded with material to create cover 504, and the material may adhere, or couple, to base 502 through the plurality of coupling points 514.

Still referring to FIGS. 36A-37, speaker 516 comprises a speaker body 517 and a speaker face 522 coupled to the speaker body 517. Speaker body 517 comprises an arcuate slot 520 configured to interface with extension 518 when speaker 516 is coupled to cover 504. In embodiments, speaker body 517 comprises a pair of apertures 524, and a pair of fasteners 526 are configured to extend through apertures 524, apertures 510 and apertures 508 to couple each of speaker 516, cover 504 and base 502. In embodiments, speaker assembly 500 is operably coupled to a radio, mobile phone, audio device, communications device, or other device capable of creating and/or distributing audio signals, and projects audio into operator area 26. In embodiments, speaker 516 is easily removably from the remainder of speaker assembly 500 (e.g., base 502 and cover 504) so that speaker 516 may be interchanged, serviced, or otherwise modified.

### Bumper Assembly

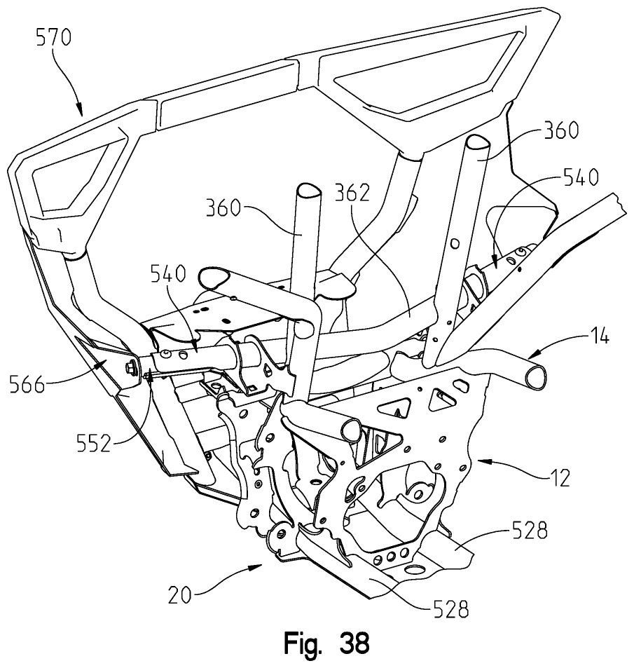

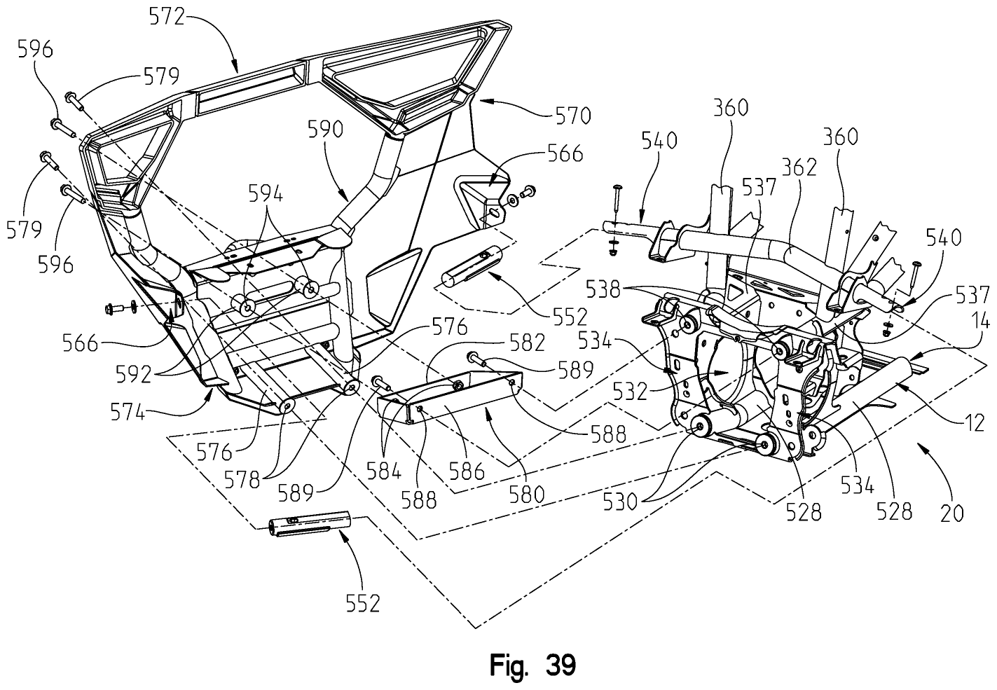

Referring now to FIGS. 38-39, a bumper assembly 570 is configured to couple to front frame portion 20. Front frame portion 20 comprises a front drive mounting area 532 configured to receive a portion of the powertrain 52 (e.g., a front drive). A pair of lower longitudinally extending frame members 528 extend to a generally forward extent of frame 12, and a pair of upper longitudinally extending frame members 537 extend to a generally forward extent of frame 12 at a position vertically above lower longitudinally extending frame members 528. A pair of upstanding members 534 extend between frame members 528 and frame members 537 to create at least a portion of front drive mounting area 532. In embodiments, vertical frame members 360 extend upwardly from frame members 537, and frame member 362 extends across each of vertical frame members 360. A pair of mounting supports 540 are positioned at either lateral extent of frame member 362. Each mounting support 540 is comprised of an arcuate upper face 542. In embodiments, each lower longitudinally extending frame member 528 comprises a forward aperture 530 facing generally forward. Further, each upper longitudinally extending frame member 537 comprises a forward aperture 538 facing generally forward.

Still referring to FIGS. 38-39, bumper assembly 570 comprises an upper portion 572 and a lower portion 574. In embodiments, upper portion 572 comprises one or more frame portions 590 configured to provide protection to one or more of grille 70, headlights, or other components on vehicle 2. Lower portion 574 comprises a plurality of frame structures including a pair of lower longitudinally extending members 576 positioned at a lower extent of bumper assembly 570 and each lower longitudinally extending member 576 comprises an aperture 578 facing generally rearwardly when in an installed configuration. Further, lower portion 574 comprises a pair of upper longitudinally extending members 592 positioned vertically above the pair of lower longitudinally extending members, and each upper longitudinally extending member 592 comprises an aperture 594 facing generally rearwardly.

A coupling frame, or bracket 580 is configured to couple between members 592 and frame members 537. That is, bracket 580 comprises a first wall 582 with a pair of apertures 584 configured to cooperate with apertures 594, and a pair of fasteners 596 are configured to extend through apertures 584 and apertures 594 to couple the coupling frame 580 to bumper assembly 570. Similarly, bracket 580 comprises a second wall 586 opposite the first wall 582 which comprises a pair of apertures 588 configured to cooperate with apertures 538, and a pair of fasteners 589 are configured to extend through apertures 588 and apertures 538 to couple bracket 580, and thereby bumper assembly 570, to front frame portion 20 at upper longitudinally extending members 537. Similarly, a pair of fasteners 479 are configured to extend through apertures 578 and apertures 530 to couple lower longitudinally extending members 576 to lower longitudinally extending members 528. Lower portion 574 also comprises a pair of extensions 566 on either lateral side of bumper assembly 570 and each extension 566 comprises an aperture 568.

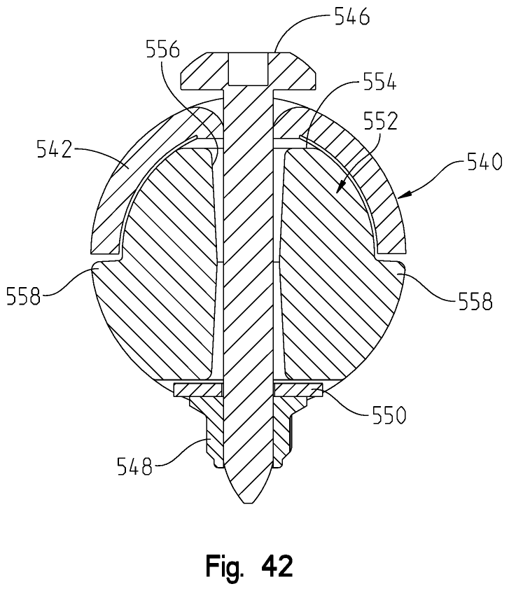

Referring now to FIGS. 39-42, a coupler 552 is generally cylindrically shaped and comprises an axial aperture 560, a keyed face 554 extending a partial length of the coupler 552, and a radial aperture 556 positioned in the keyed face 554. Further, coupler 552 comprises a flange 558 extending around a portion of the perimeter of the coupler 552. Illustratively, flange 558 extends around approximately 50% of the perimeter of the coupler 552. A fastener 562 is configured to extend through a washer 564 and fastener 562 is configured to extend through aperture 568 and aperture 560 to couple the coupler 552 to extensions 566. Further, a fastener 546 is configured to extend through aperture 544 and aperture 556 to couple the coupler 552 and bumper assembly 570 to frame 12 at mounting supports 540.

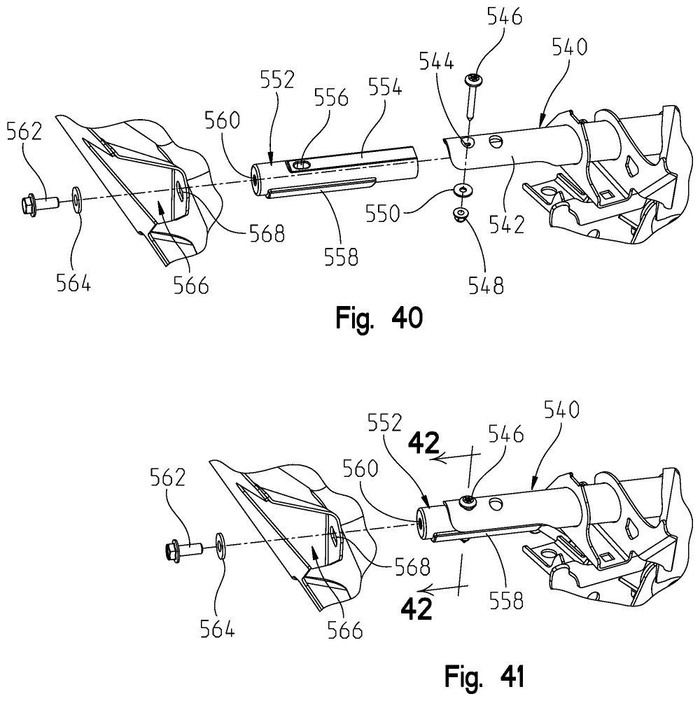

Referring now to FIGS. 40-41, coupler 552 is configured to be inserted into mounting supports 540. That is, coupler 552 is shaped to fit and cooperate with the partial arcuate shape of arcuate upper face 542. Further, when coupler 552 is inserted into, and cooperating with mounting supports 540, radial aperture 556 aligns with aperture 544 and fastener 546 is inserted through each of aperture 544 and radial aperture 556 to couple coupler 552 to mounting supports 540. Further, flange 558 acts as an anti-rotation feature by abutting arcuate upper face 542 when properly assembled into mounting supports 540. Coupler 552 provides an additional mounting point for bumper assembly 570 to couple to frame 12. That is, bumper assembly 570 has mounting points on the left and right side of frame 12 (i.e., mounting supports 540) and four mounting points towards the middle of frame 12 (i.e., at front drive mounting area 532 and frame members 537).

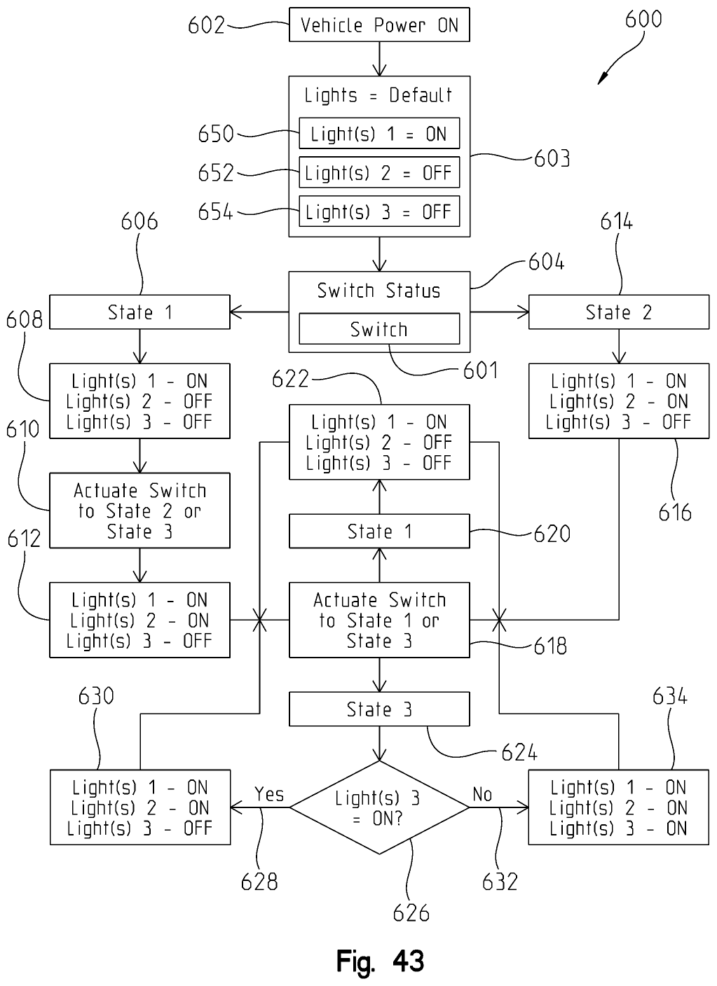

Referring now to FIG. 43, a method 600 of operating one or more lights or accessories on vehicle 2, 2′ is described. In embodiments, method 600 is controlled by, or carried out by, a controller of vehicle 2, 2′, (e.g., controller 98) or by processing system 100. Method 600 begins when vehicle 2, 2′ is powered on, as illustrated in block 602, and one or more light(s) 650, 652, 654 are set to a default state, as identified in block 603. Further, the status of a switch 601 (e.g., a user input 92 on dashboard 44 or a steering wheel (not shown)) is determined, as identified in block 604. In embodiments, the switch 601 used with method 600 is a momentary switch with three states including a first discrete state (e.g., a first state), a second discrete state (e.g., a second state), and a momentary state (e.g., a third state). In embodiments, the momentary switch 601 may be set to the first state, the second state, or the third state may be momentarily actuated to alter the operation of the one or more lights or accessories on vehicle 2, 2′. In embodiments, when switch 601 is switched to the third state, it automatically returns to the second discrete state. That is, switch 601 is momentarily in the third state but defaults back to the second state after actuation into the third state, and the actuation into the third state may send a discrete signal to controller 98. In embodiments, the momentary switch 601 of method 600 is configured to control a first light 650, or first set of lights (e.g., accessory lights or accent lights), a second light 652, or second set of lights (e.g., low beam lights), and a third light 654, or third set of lights (e.g., high beam lights).

Referring still to FIG. 43, when the momentary switch is determined to be in the first state (e.g., a first discrete state), as identified in block 606, controller 98 operates the first light(s) 650 in an ON-state, the second light(s) 652 in an OFF-state, and the third light(s) 654 in an OFF-state, as identified in block 608. That is, in the first state, controller 98 operates only the accessory lights 650, or accent lights, in an ON-state. Controller 98 determines that the switch 601 is in the first state and subsequently monitors if the switch 601 is actuated into the second state or the third state (e.g., switched upwardly) as identified by block 610, and in response to switch 601 being actuated into the second state or the third state from the first state (e.g., switched upwardly), the controller 98 operates the first light(s) 650 in an ON-state, the second light(s) 652 in an ON-state, and the third light(s) 654 in an OFF-state, as identified in block 612. That is, in block 612, controller 98 operates only the accessory lights 650, or accent lights, and the low beam lights 652 in an ON-state. Referring again to method 600 at block 604, controller 98 may determine that switch 601 is in the second state, as identified in block 614, and controller 98 operates the first light(s) 650 in an ON-state, the second light(s) 652 in an ON-state, and the third light(s) 654 in an OFF-state, as identified in block 616. That is, in block 616, controller 98 operates only the accessory lights 650, or accent lights, and the low beam lights 652 in an ON-state.

Referring still to FIG. 43, controller 98 operates lights 650, 652, 654 according to blocks 612, 616, and subsequently monitors switch 601 for an additional input (e.g., toward the first state or third state). That is, at each of blocks 612, 612, switch 601 is in the second discrete state and is prepare to receive a momentary input to the third state or a discrete input to the first state. In embodiments, controller 98 receives an actuation into the first state or the third state, as identified by block 618. In embodiments, the actuation input to switch 601 at block 618 is an actuation into the first state (e.g., the discrete first state) as identified by block 620, and controller 98 operates the first light(s) 650 in an ON-state, the second light(s) 652 in an OFF-state, and the third light(s) 654 in an OFF-state, as identified in block 622. That is, in block 622, controller 98 operates only the accessory lights 650, or accent lights in an ON-state. In embodiments, the actuation input to switch 601 at block 618 is an actuation into the third state (e.g., the momentary third state) as identified by block 624, and controller 98 determines if the third lights (e.g., high beam lights) are currently in an ON-state, as identified in block 626. If controller 98 determines that the third lights (e.g., high beam lights) are currently in an ON-state, as identified in block 628, controller 98 proceeds to operate the first light(s) 650 in an ON-state, the second light(s) 652 in an ON-state, and the third light(s) 654 in an OFF-state, as identified in block 630. That is, in response to an input to the switch 601 identifying the third momentary state, as identified in block 624, when the third lights (e.g., high beam lights) are currently in an ON-state, as identified in block 626, the controller 98 determines that the high beam lights should be altered, or turned to an OFF-state. If controller 98 determines that the third lights (e.g., high beam lights) are currently in an OFF-state, as identified in block 632, controller 98 proceeds to operate the first light(s) 650 in an ON-state, the second light(s) 652 in an ON-state, and the third light(s) 654 in an ON-state, as identified in block 634. That is, in response to an input to the switch 601 identifying the third momentary state, as identified in block 624, when the third lights (e.g., high beam lights) are currently in an OFF-state, the controller 98 determines that the high beam lights should be altered, or turned to an ON-state. Subsequent to controller 98 operating lights 650, 652, 654 according to either block 630 or 634, process 600 returns to block 618 to look for a new input to switch 601, and an input to the switch 601 to the first discrete state will proceed, again, to block 620 and block 622, and an input to the switch 601 to the third momentary state will proceed, again, through process 600 at block 624.

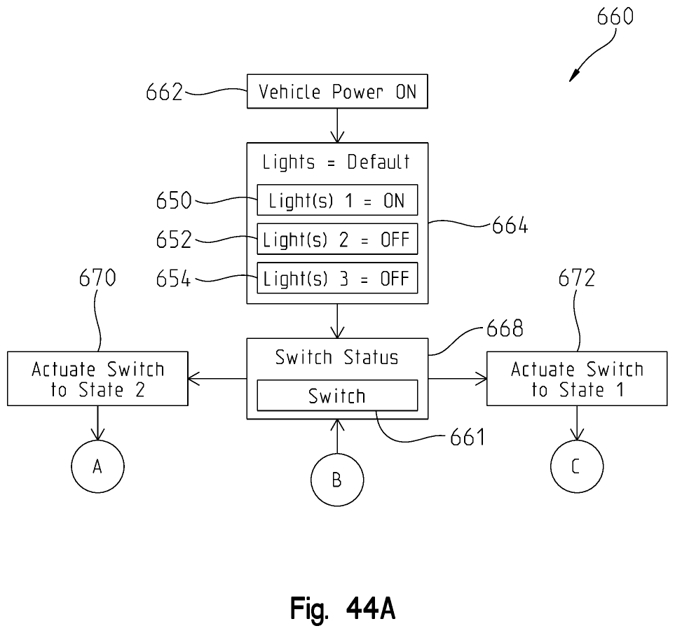

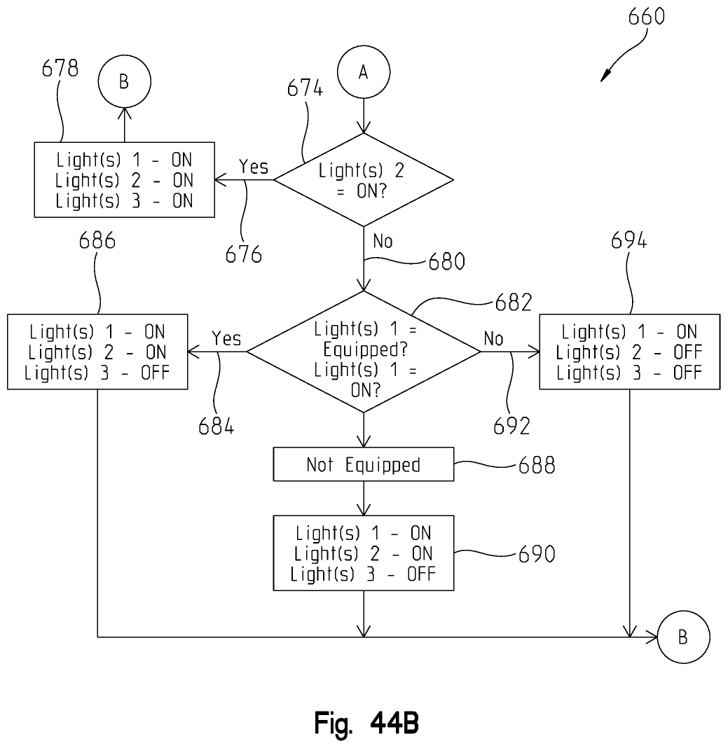

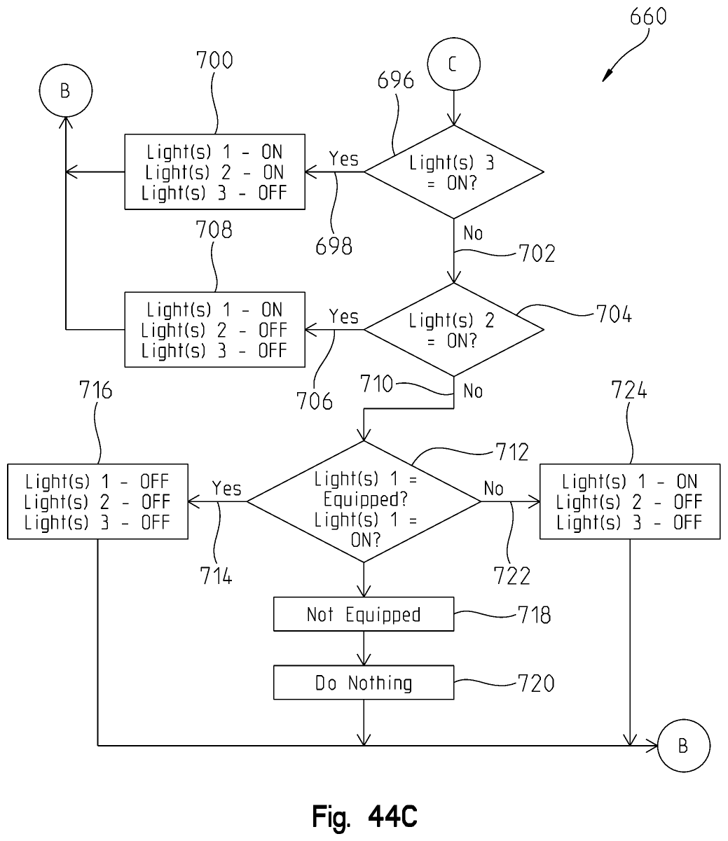

Referring now to FIGS. 44A-44C, an alternative method 660 of controlling one or more lights (e.g., lights 650, 652, 654) or accessories on vehicle 2, 2′ is provided. Method 660 begins when vehicle 2, 2′ is powered on, as illustrated in block 662, and one or more light(s) 650, 652, 654 are set to a default state, as identified in block 664. In embodiments, as described above, light(s) 650 are accent lights, or accessory lights, second lights 652 are low-beam lights and third lights 654 are high-beam lights.

Further, the status of a switch 661 (e.g., similar to switch 601; a user input 92 on dashboard 44 or a steering wheel (not shown)) is determined, as identified in block 668. Switch 661 may be a momentary switch with one or more states. In embodiments, switch 661 has a first momentary state, a discrete state, and a second momentary state. That is, switch 661 may default to the discrete state (e.g., a neutral state) and be momentarily actuated to either the first momentary state (e.g., a downward actuation) or the second momentary state (e.g., an upward actuation). That is, switch 661 may be momentarily actuated in either the first or second momentary states, but may default back to the discrete state (e.g., neutral state) after actuation into either the first or second momentary states, and the actuation into the first or second momentary states may send a discrete signal to controller 98.

Referring still to FIGS. 44A-44C, method 660 determines the status of switch 661, as identified in block 668, and in embodiments, method 660 determines that switch 661 has received an upward actuation to the second momentary state, as identified in block 670, and proceeds to subprocess A (FIG. 44B). In embodiments, method 660 determines that switch 661 has received a downward actuation to the first momentary state, as identified in block 672, and method 660 proceeds to subprocess C (FIG. 44C). In embodiments, if no input is received to switch 661, method 660 remains at block 668, and lights 650, 652, 654 operate in a default state (e.g., light(s) 650=ON-state; light(s) 652=OFF-state; light(s) 654=OFF-state.)

Referring now to FIG. 44B, subprocess A continues from block 670, and controller 98 determines if the second lights 652 are in an ON-state, as identified in block 674, and in response to the second lights 652 being in an ON-state as identified in block 676, controller 98 operates first lights 650 in an ON-state, second lights 652 in an ON-state, and third lights 654 in an ON-state, as indicated in block 678. That is, in response to the low-beam lights (e.g., second lights 652) being in an ON-state and receiving an upward actuation (e.g., input to second momentary state), controller 98 increases the light output by altering the high beams (e.g., third lights 654) to an ON-state. Controller 98 continues to operate lights 650, 652, 654 according to block 678 until a new input is received by switch 661 at block 668. In embodiments, controller 98 determines if the second lights 652 are in an ON-state, as identified in block 674, and in response to the second lights 652 being in an OFF-state as identified in block 680, controller 98 determines if the first lights 650 (e.g., accent lights or accessory lights) are equipped (e.g., installed) on vehicle 2, 2′, and if the first lights 650 are in an ON-state, as identified in block 682. If the first lights 650 (e.g., accent lights or accessory lights) are equipped (e.g., installed) on vehicle 2, 2′ and in an ON-state as identified in block 684, controller operates first lights 650 in an ON-state, second lights 652 in an ON-state, and third lights 654 in an OFF-state, as identified in block 686. If the first lights 650 (e.g., accent lights or accessory lights) are not equipped (e.g., not installed) on vehicle 2, 2′ as identified in block 684, controller operates first lights 650 in an ON-state, second lights 652 in an ON-state, and third lights 654 in an OFF-state, as identified in block 686. That is, even though first lights 650 are not equipped on vehicle 2, 2′, controller 98 still operates second lights 652 so that vehicle 2, 2′ has one of lights 650, 652, 654 in an ON-state in response to an upward actuation (block 670). If the first lights 650 (e.g., accent lights or accessory lights) are in an OFF-state as identified in block 692, controller operates first lights 650 in an ON-state, second lights 652 in an OFF-state, and third lights 654 in an OFF-state, as identified in block 694. Controller 98 continues to operate lights 650, 652, 654 according to one of blocks 686, 690, 694 until a new input is received by switch 661 at block 668.

Referring now to FIG. 44C, subprocess C continues from block 672, and controller 98 determines if the third lights 654 are in an ON-state, as identified in block 696, and in response to the third lights 654 being in an ON-state as identified in block 698, controller 98 operates first lights 650 in an ON-state, second lights 652 in an ON-state, and third lights 654 in an OFF-state, as indicated in block 700. That is, in response to the low-beam lights (e.g., second lights 652) being in an ON-state and the high-beam lights (e.g., third lights 654) being in an ON-state and receiving a downward actuation (e.g., input to the first momentary state), controller 98 reduces the light output by altering the high beams (e.g., third lights 654) to an OFF-state. Controller 98 continues to operate lights 650, 652, 654 according to block 700 until a new input is received by switch 661 at block 668. In embodiments, controller 98 determines if the third lights 654 are in an ON-state, as identified in block 696, and in response to the third lights 654 being in an OFF-state as identified in block 702, controller 98 subsequently determines if the second lights 652 are in on On-state, as identified in block 704. In response to the second lights 652 being in an ON-state, as indicated in block 706, controller 98 operates first lights 650 in an ON-state, second lights 652 in an OFF-state, and third lights 654 in an OFF-state, as indicate din block 708. That is, in response to the low-beam lights (e.g., second lights 652) being in an ON-state and the high-beam lights (e.g., third lights 654) being in an OFF-state and receiving a downward actuation (e.g., input to the first momentary state), controller 98 reduces the light output by altering the low beams (e.g., second lights 652) to an OFF-state. Controller 98 continues to operate lights 650, 652, 654 according to block 706 until a new input is received by switch 661 at block 668.

Referring still to FIG. 44C, in response to the second lights 652 being in an OFF-state, as indicated in block 710, controller 98 determines if first lights 650 are equipped (e.g., installed) and if first lights 650 are in an ON-state, as indicated in block 712. If it is determined that first lights 650 are equipped (e.g., installed) and in an ON-state, as indicated in block 714, controller 98 operates first lights 650 in an OFF-state, second lights 652 in an OFF-state, and third lights 654 in an OFF-state. That is, when vehicle 2, 2′ is equipped with first lights 650, in response to third lights 654 being in an OFF-state, second lights 652 being in an OFF-state, third lights 650 being in an ON-state, and a downward actuation (e.g., input to the first momentary state), controller 98 reduces the light output by altering the accent lights, or accessory lights (e.g., third lights 650) to an OFF-state. Controller 98 continues to operate lights 650, 652, 654 according to block 716 until a new input is received by switch 661 at block 668.

Referring still to FIG. 44C, if it is determined that first lights 650 are not equipped (e.g., not installed), as indicated in block 718, controller 98 does not change anything. That is, when vehicle 2, 2′ is not equipped with first lights 650, in response to third lights 654 being in an OFF-state, second lights 652 being in an OFF-state, and a downward actuation (e.g., input to the first momentary state), controller 98 does not change anything. Controller 98 continues to operate lights 650, 652, 654 according to block 720 until a new input is received by switch 661 at block 668.

Referring still to FIG. 44C, if it is determined that first lights 650 are equipped (e.g., installed) and in an OFF-state, as indicated in block 722, controller 98 operates first lights 650 in an ON-state, second lights 652 in an OFF-state, and third lights 654 in an OFF-state. That is, when vehicle 2, 2′ is equipped with first lights 650, in response to third lights 654 being in an OFF-state, second lights 652 being in an OFF-state, third lights 650 being in an OFF-state, and a downward actuation (e.g., input to the first momentary state), controller 98 increases the light output by altering the accent lights, or accessory lights (e.g., third lights 650) to an ON-state. Controller 98 continues to operate lights 650, 652, 654 according to block 724 until a new input is received by switch 661 at block 668.

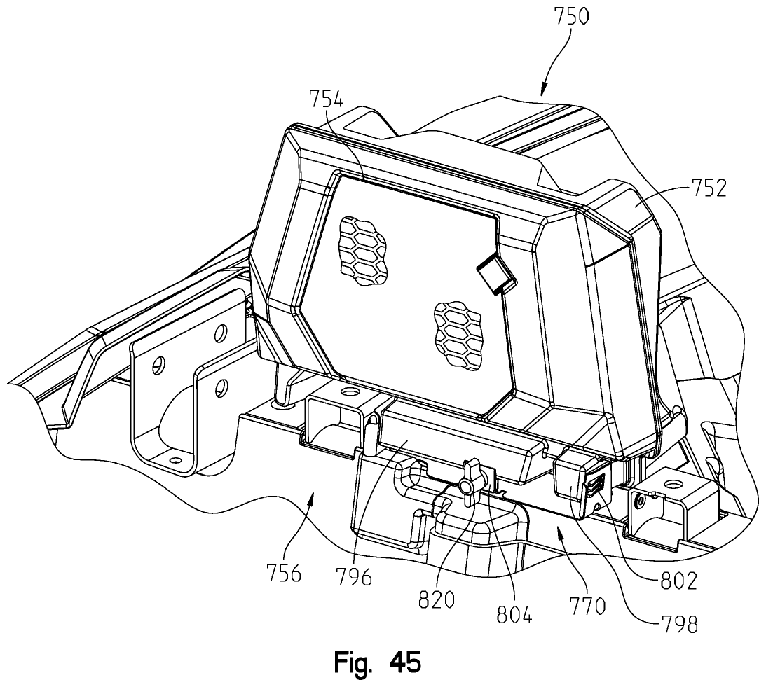

Referring now to FIGS. 45-48, vehicle 2, 2′ includes a speaker 750 which includes a housing 752 and a speaker opening 754. In embodiments, speaker 750 is substantially similar to, or the same as speaker 486 (FIG. 33). In embodiments, vehicle 2, 2′ includes a rear panel 756 which may be substantially similar to rear panel 283. A top panel 758 may be coupled to rear panel 756, and top panel 758 defines a first aperture 760 and a second aperture 762. Top panel 758 also defines an aperture 764, a first receiving shell 766 and a second receiving shell 768. Top panel 758 also defines a pair of apertures 770.

Still referring to FIGS. 45-48, a bracket 771 couples between top panel 758 and speaker 750. Bracket 771 includes a main body portion 772, a first extension 774 extends upwardly from main body portion 772 and defines a first edge extension 776, a second edge extension 778 and an aperture 775, and a second extension 780 extends upwardly from main body portion 772 opposite the first extension 774 and second extension 780 defines a first edge extension 782, a second edge extension 784, and an aperture 781. A tab 786 extends upwardly from main body portion 772 intermediate first extension 774 and second extension 780, and tab 786 defines an aperture 788. Additionally, main body portion 772 defines a pair of apertures 790. Bracket 771 sits upon top panel 758 and a pair of fasteners 792 extend through apertures 790 and apertures 770 to couple bracket 771 to top panel 758. In embodiments, each of rear panel 756 and top panel 758 are coupled to a frame member 757, and each fastener 792 couple to frame member 757 to couple bracket 771 to each of top panel 758 and frame member 757.

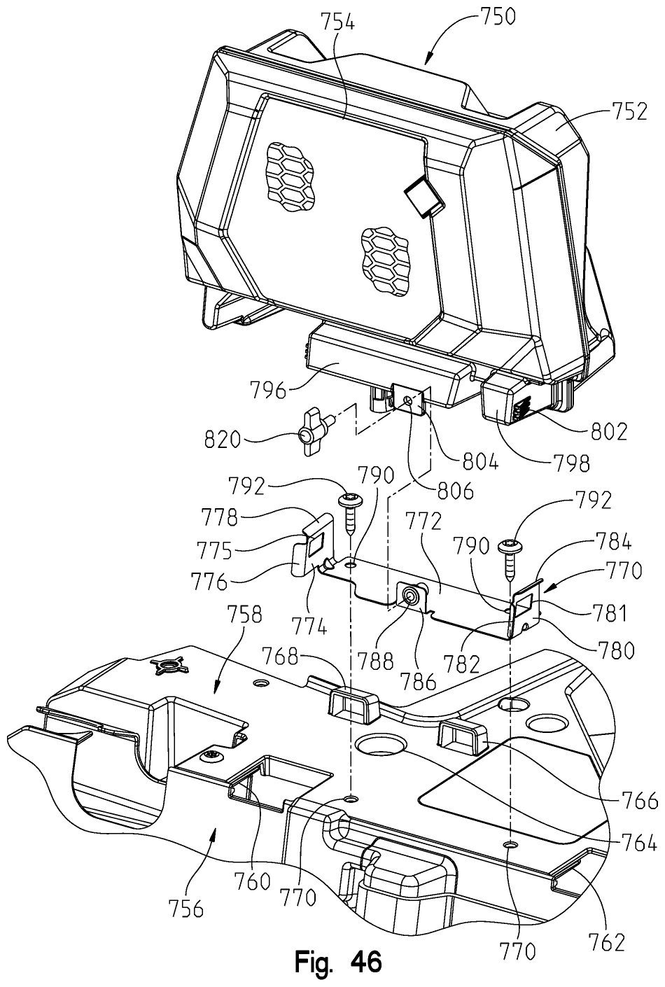

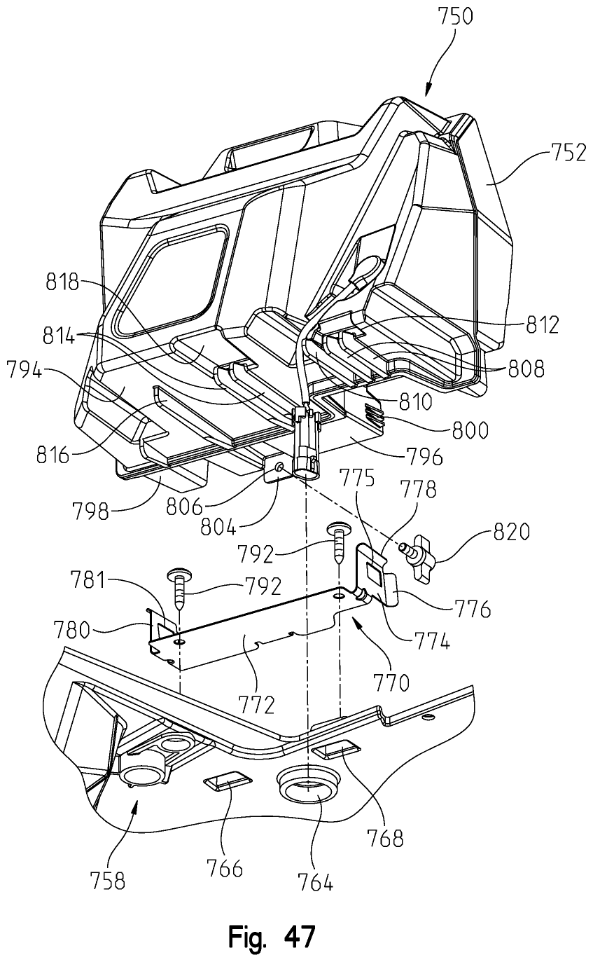

Referring to FIGS. 46-47, speaker 750 defines a lower portion 794, a first forward projection 796, a second forward projection 798, and a tab 804 extending downwardly from first forward projection 796, and tab 804 defines an aperture 806. First forward projection 796 defines a plurality of sloped ribs 800 and second forward projection 798 defines a plurality of sloped ribs 802. Lower portion 794 defines a first recess 812 and a second recess 818. A first pair of ribs 808 extend downwardly from lower portion 794 and extend rearwardly and cantilevered across a portion of first recess 812. Further, a rib 810 extends downwardly from lower portion 794 and extends along at least one of ribs 808. A second pair of ribs 814 extend downwardly from lower portion 794 and extend rearwardly and cantilevered across a portion of second recess 818. A rib 816 extends downwardly from lower portion 794 and generally along ribs 814.

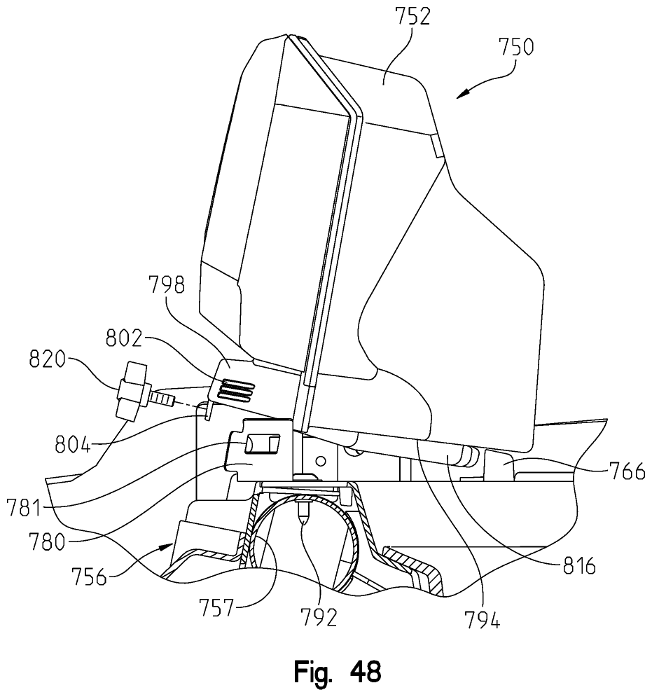

Referring now to FIG. 48, speaker 750 couples to top panel 758 adjacent rear panel 756 by coupling with each of first receiving shell 766 and second receiving shell 768. That is, speaker 750 may be placed downwardly onto top panel 758 such that the pair of ribs 808 extend into second receiving shell 768 and the pair of ribs 814 extend into first receiving shell 766. Ribs 808, 814 are secured within each of first receiving shell 766 and second receiving shell 768. Further, a front of speaker 750 may be rotated downwardly such that front projections 796, 798 couple to bracket 771. In embodiments, sloped ribs 800 are seated within aperture 775 and sloped ribs 802 are seated within aperture 781 such that speaker 750 is retained by bracket 771. In embodiments, sloped ribs 800 are configured to slide along one or more of first edge extension 776 and second edge extension 778 such that ribs 800 slide into aperture 775 and ribs 802 are configured to slide along one or more of first edge extension 782 and second edge extension 784 such that ribs 802 slide into aperture 781. Further, as speaker 750 rotates downwardly and couples with bracket 771, aperture 806 of tab 804 aligns with aperture 788 of tab 786, and a fastener 820 (e.g., screw) extends through aperture 788 and aperture 806 to couple speaker 750 to bracket 771.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A vehicle, comprising:
a plurality of ground engaging members;
a frame supported by the plurality of ground engaging members, the frame generally comprising a front frame portion;
an operator area supported by the frame;
at least one seat supported by the frame and positioned within the operator area;
a body assembly comprising a plurality of body panels, the plurality of body panels including a first body panel supported by the front frame portion, the first body panel comprising an aperture, and a second body panel removably coupled to the frame, the second body panel positioned at least partially rearwardly of the first body panel; and
a passageway fluidly coupled between the aperture and the operator area, the passageway extending behind the second body panel.

2. The vehicle of claim 1, further comprising a panel positioned vertically below the first body panel, and the panel comprises a chamber fluidly coupled between the aperture and the operator area.

3. The vehicle of claim 2, wherein the panel comprises an inlet portion and an outlet portion, and the inlet portion is coupled to the aperture and the outlet portion is coupled to a duct.

4. The vehicle of claim 3, further comprising an angled wall positioned fluidly intermediate the inlet portion and the outlet portion.

5. The vehicle of claim 1, further comprising one of a filter or a fan positioned along the passageway.

6. The vehicle of claim 1, wherein a portion of the passageway extends at a position laterally outwardly from the at least one seat.

7. The vehicle of claim 1, wherein the aperture is positioned at a first vertical height, and the passageway is fluidly coupled to the operator area at a second vertical height less than the first vertical height.

8. The vehicle of claim 1, wherein the aperture is facing generally forwardly.

9. A vehicle, comprising:
a plurality of ground engaging members;
a frame supported by the plurality of ground engaging members;
an operator area supported by the frame, the operator area comprising at least one seat;
a powertrain coupled to at least one of the plurality of ground engaging members;
a heat exchanger supported by the frame, the heat exchanger positioned forward of the operator area;
a panel positioned longitudinally intermediate the heat exchanger and the operator area, the panel configured to divert air laterally outwardly.

10. The vehicle of claim 9, wherein the panel is positioned behind the radiator between approximately one-fifth and one-half the distance between the heat exchanger and the operator area.

11. The vehicle of claim 9, wherein the panel is positioned behind the radiator approximately one-third the distance between the heat exchanger and the operator area.

12. The vehicle of claim 9, wherein each of the heat exchanger and the panel are positioned along a longitudinal centerline of the vehicle.

13. The vehicle of claim 12, wherein each of the heat exchanger and the panel are angled relative to a line perpendicular to the longitudinal centerline.

14. The vehicle of claim 9, wherein a width of the panel is equal to or greater than a width of the heat exchanger.

15. The vehicle of claim 9, wherein the heat exchanger is a radiator configured to provide cooling fluid to at least a portion of the powertrain.

16. The vehicle of claim 15, further comprising a fan coupled to the radiator, the fan configured to direct air at the panel.

17. The vehicle of claim 9, wherein the panel is configured to receive a frame member of the front frame portion.

18.-26. (canceled)

27. A vehicle, comprising:
a plurality of ground engaging members;
a frame supported by the plurality of ground engaging members, the frame comprising a lower frame portion and an upper frame portion;
a first suspension coupled between the lower frame portion and at least one of the plurality of ground engaging members;
an operator area surrounded by the upper frame portion;
at least one seat positioned within the operator area;
a controller supported by the frame, the controller operably coupled to a first communication device, a second communication device, and a third communication device;
a body assembly comprising a plurality of body panels supported by the frame, the plurality of body panels including a first body panel positioned vertically above a portion of the first suspension;
a panel positioned vertically intermediate the first body panel and the first suspension, the panel configured to receive at least two of the first communication device, second communication device and the third communication device.

28. The vehicle of claim 27, wherein the panel further comprises a plurality of recesses, including a first recess and a second recess, and the first recess is configured to receive at least one of the first communication device, second communication device, and third communication device, and the second recess is configured to receive another one of the first communication device, second communication device, and third communication device.

29. The vehicle of claim 28, wherein the first recess comprises a drain hole.

30. The vehicle of claim 27, wherein each of the first communication device, second communication device, and third communication device are positioned forwardly of the upper frame portion.

31. The vehicle of claim 27, wherein the first communication device is an AM/FM antenna, the second communication device is a high frequency antenna, and the third communication device is a cellular network communication device.

32. The vehicle of claim 31, further comprising a fourth communication device configured to be placed adjacent a front of the vehicle, the fourth communication device being a GPS.

33. The vehicle of claim 32, wherein the GPS and the AM/FM antenna are positioned longitudinally forward of the high frequency antenna and the cellular network communication device.

34. The vehicle of claim 27, wherein the vehicle comprises a powertrain, and a portion of the powertrain is configured to extend through the panel.

35.-43. (canceled)
